(19) United States
(12) Patent Application Publication
(10) Pub. No.: US 2025/0345848 A1
(43) Pub. Date: Nov. 13, 2025

(54) RUTHENIUM-MOLYBDENUM ALLOY NANOFLOWER PARTICLE FOR AMMONIA ELECTROSYNTHESIS

(71) Applicant: City University of Hong Kong, Hong Kong (CN)

(72) Inventors: Zhanxi FAN, Hong Kong (CN); Yunhao WANG, Hong Kong (CN); Fengkun HAO, Hong Kong (CN)

(21) Appl. No.: 18/657,178

(22) Filed: May 7, 2024

(51) Int. Cl. B22F 1/054; B22F 9/24; B82Y 30/00; B82Y 40/00; C25B 1/27; C25B 11/037

(52) U.S. Cl. CPC B22F 1/0553; B22F 9/24; C25B 1/27; C25B 11/037; B22F 2301/25; B22F 2304/054; B82Y 30/00; B82Y 40/00

(57) ABSTRACT

Ruthenium-molybdenum alloy nanoflower particles having a plurality of ruthenium-molybdenum nanosheets, wherein the plurality of ruthenium-molybdenum nanosheets are in a form of a nanoflower useful for the electrochemical synthesis of ammonia; an electrode including the ruthenium-molybdenum alloy nanoflower particles; and methods of preparation and use thereof.

### STATEMENT REGARDING PRIOR DISCLOSURES BY THE INVENTORS OR JOINT INVENTORS UNDER 37 CFR 1.77 (b) (6)

Part of the present invention was disclosed in a paper published in Yunhao Wang, et al., Crystal Phase Engineering of Ultrathin Alloy Nanostructures for Highly Efficient Electroreduction of Nitrate to Ammonia, Adv Mater. 2024 April; 36(14):e2313548. This paper is a grace period inventor-originated disclosure disclosed within one year before the filing date of this application and falls within the exceptions defined under 35 USC § 102 (b)(1). These papers are hereby incorporated by reference in their entirety.

### TECHNICAL FIELD

The present disclosure generally relates to a ruthenium-molybdenum alloy nanoflower particle useful as an electrocatalyst in electrochemical synthesis of ammonia.

### BACKGROUND

Ammonia (NH₃) is not only an indispensable chemical feedstock for nitrogen fertilizer production, but also a promising carbon-free energy carrier. At present, the industrial-scale ammonia synthesis is still dominated by the energy-intensive and environmentally damaging Haber-Bosch process, which accounts for 1-2% of worldwide energy consumption and 1.44% of global carbon dioxide emission. Recently, electrocatalytic nitrate (NO₃⁻) reduction reaction (NO₃RR) with net-zero carbon emission has been regarded as a promising approach to NH₃ synthesis. Benefiting from the low bond energy of N—O bonds (204 KJ mol⁻¹) as well as the large solubility of NO₃⁻ in aqueous solutions, NO₃RR provides a feasible method for NH₃ production with high efficiency and selectivity. More importantly, NO₃⁻ has become one of the most widely existing water contaminations, arising from the cumulation of agricultural runoffs and discharging of industrial sewage. Therefore, electrochemical NO₃RR is a versatile strategy for NH₃ synthesis along with pollutant removal from water bodies.

The electrocatalytic NO₃RR is a complicated reaction process involving eight electrons and nine protons (i.e., NO₃⁻+9H⁺+8e⁻→NH₃+3H₂O), resulting in sluggish kinetics. Meanwhile, the side reactions with the formation of byproducts, such as NO₂⁻, NH₂OH, NO, N₂, N₂O and hydrogen (H₂), disfavor the NH₃ production. Recently, ruthenium (Ru)-based catalysts have been extensively investigated in NO₃RR owing to their high activity in converting NO₂⁻ to NH₃. However, in contrast to the strong affinity of active hydrogen on the surface of Ru electrocatalysts, the weak affinity of NO₃⁻ originating from its symmetrical (D₃ₕ) resonant structure greatly restricts the efficient conversion of NO₃⁻ to NO₂⁻, which is commonly deemed as the rate-determining step, leading to unsatisfactory NH₃ Faradaic efficiency (FE) and yield rate. Although many strategies like morphology design, strain engineering and alloy construction have been developed to improve the catalytic performance toward NO₃RR, it is still inefficient to convert NO₃⁻ to NH₃. In addition, almost all of the previously reported Ru-based catalysts adopt the conventional crystal phase, i.e., hexagonal close-packed (hcp), which could greatly limit the further enhancement of NO₃RR performance. Recently, crystal phase engineering of nanomaterials has emerged as a promising strategy to boost the catalytic performance of nanomaterials. In particular, it has been found that unconventional phase nanomaterials, such as face-centered cubic (fcc)-2H-fcc gold nanorods, 4H/fcc and 4H copper nanorods, 4H/fcc iridium nanostructures, 2H palladium-copper alloys, body-centered cubic palladium-copper nanocubes and 2H platinum-nickel nanobranches, demonstrate superior catalytic activities over their conventional phase counterparts. In light of this, regulating the crystal phase of Ru-based nanomaterials could boost their catalytic activity toward NO₃RR. On the other hand, in the biological NO₃RR process, the conversion of NO₃⁻ to NO₂⁻ is catalyzed over a molybdenum (Mo)-cofactor in nitrate-reductase. Therefore, synthesis of Mo-incorporated Ru-based nanomaterials with unconventional phase should be a feasible way to achieve the highly efficient conversion of NO₃⁻ to NH₃.

There is thus a need for improved NO₃RR Ru-based electrocatalysts.

### SUMMARY

The present disclosure provides RuMo alloy nanoflower (NF) particles with unconventional fcc phase and hcp/fcc heterophase that can be synthesized using the one-pot solvothermal method. Compared with the heterophase hcp/fcc RuMo NFs and hcp/fcc Ru nanosheets (NSs), the as-synthesized fcc RuMo NFs show superior catalytic performance in NO₃RR toward NH₃ synthesis. Impressively, fcc RuMo NFs demonstrate excellent FE of 95.2% and high half-cell energy efficiency (EE) of 41.9% at 0 V (vs reversible hydrogen electrode (RHE)) as well as large yield rate of 32.7 mg h⁻¹ mg_{cat}⁻¹ at −0.1 V (vs RHE) toward NH₃ production. In addition, the outstanding catalytic durability of fcc RuMo NFs for NO₃RR is confirmed by the 20 consecutive electrolysis cycles and the long-term chronoamperometry test. In-situ differential electrochemical mass spectrometry (DEMS) results indicate that fcc RuMo NFs display much lower onset potential for NH₃ formation than that of hcp/fcc RuMo NFs and hcp/fcc Ru NSs. Density functional theory (DFT) calculations have revealed that the introduction of Mo optimizes the overall electroactivity to benefit the adsorption of nitrate and supply of active hydrogen from water dissociation, leading to much lower energy barriers of NO₃RR. The fcc RuMo alloy NFs show higher electron transfer efficiency than the control electrocatalysts with hcp/fcc heterophase, suggesting the higher electroactivity of unconventional fcc phase than common hcp phase. In addition, the zinc-nitrate (Zn—NO₃⁻) battery is assembled by using fcc RuMo NFs as the cathode catalyst, which delivers an outstanding specific capacity of 195,042 mAh g_{cat}⁻¹ under the discharge current density of 2.5 mA mg_{cat}⁻¹.

In a first aspect, provided herein is a ruthenium-molybdenum (RuMo) alloy nanoflower particle comprising: a plurality of RuMo nanosheets, wherein the plurality of RuMo nanosheets are in a form of a nanoflower.

In certain embodiments, the plurality of RuMo nanosheets comprise RuMo in a face-centered cubic (fcc) phase or a heterophase comprising a hexagonal close-packed (hcp) phase and a face-centered cubic (fcc) phase.

In certain embodiments, the RuMo alloy nanoflower particle has a diameter of 20-100 nm.

In certain embodiments, the plurality of RuMo nanosheets have an average thickness of 2.3-3.3 nm or 2.6-3.6 nm.

In certain embodiments, the plurality of RuMo nanosheets have an average thickness of 2.6-3.0 nm or 2.9-3.3 nm.

In certain embodiments, the RuMo alloy nanoflower particle comprises Ru and Mo in an atomic ratio of 85:15 to 95:5, respectively.

In certain embodiments, the RuMo alloy nanoflower particle comprises Ru and Mo in an atomic ratio of 89.9:10.1 to 91.4:9.6, respectively.

In certain embodiments, the plurality of RuMo nanosheets comprise RuMo in a face-centered cubic (fcc) phase; the plurality of RuMo nanosheets have an average thickness of 2.6-3.0 nm; and the RuMo alloy nanoflower particle comprises Ru and Mo in an atomic ratio of 89.9:10.1 to 91.4:9, respectively; or the plurality of RuMo nanosheets comprise RuMo in a heterophase comprising a hexagonal close-packed (hcp) phase and a face-centered cubic (fcc) phase; the plurality of RuMo nanosheets have an average thickness of 2.9-3.3 nm; and the RuMo alloy nanoflower particle comprises Ru and Mo in an atomic ratio of 89.9:10.1 to 91.4:9, respectively.

In certain embodiments, the plurality of RuMo nanosheets comprise RuMo in a face-centered cubic (fcc) phase; the plurality of RuMo nanosheets have an average thickness of 2.6-3.0 nm; and the RuMo alloy nanoflower particle comprises Ru and Mo in an atomic ratio of 89.9:10.1 to 91.4:9, respectively.

In certain embodiments, the RuMo alloy nanoflower particle is prepared by a method comprising: combining Ru₃(CO)₁₂, Mo(CO)₆, glucose, and citric acid or salicylic acid in a solvent comprising oleylamine thereby forming a reaction solution and heating the reaction solution thereby forming the RuMo alloy nanoflower particle.

In a second aspect, provided herein is an electrode comprising the RuMo alloy nanoflower particle described herein and a base electrode.

In a third aspect, provided herein is an electrochemical cell comprising: the electrode described herein; a counter electrode; optionally a reference electrode; and an electrolyte solution between and in contact with the electrode, the counter electrode, and optionally the reference electrode.

In a fourth aspect, provided herein is a method of producing ammonia, the method comprising: providing the electrochemical cell described herein, wherein the electrolyte solution comprises a substrate selected from the group consisting of a nitrate salt, a nitrite salt, nitric oxide, nitrogen (N₂), and a mixture thereof; and applying a potential between the electrode and the counter electrode resulting in the electrolytic reduction of the substrate thereby forming ammonia.

In certain embodiments, the potential is-0.1 to 0.05 volts vs reversible hydrogen electrode.

In certain embodiments, the nitrate salt is present in the electrolyte solution at a concentration of 0.01 to 0.1 M.

In certain embodiments, the method has a NH₃ Faradaic efficiency (FE) of 91.7%-95.2% at −0.1 to 0 V vs reversible hydrogen evolution.

In a fifth aspect, provided herein is a method of preparing the RuMo alloy nanoflower particle described herein, the method comprising: combining Ru₃(CO)₁₂, Mo(CO)₆, glucose, and citric acid or salicylic acid in a solvent comprising oleylamine thereby forming a reaction solution and heating the reaction solution thereby forming the RuMo alloy nanoflower particle. In certain embodiments, the reaction solution is heated at a temperature of 150-250° C.

### BRIEF DESCRIPTION OF THE DRAWINGS

The foregoing aspects and many of the attendant advantages of this invention will become more readily appreciated and understood by reference to the following detailed description, when taken in conjunction with the accompanying drawings.

FIG. 1 depicts synthesis and structural characterizations. a) Schematic illustration of the one-pot solvothermal synthesis of unconventional fcc phase and hcp/fcc heterophase RuMo alloy NFs for NO₃RR. b,c) HAADF-STEM (b) and atomic resolution HAADF-STEM (c) images of fcc RuMo NFs. Inset of (c): the corresponding FFT pattern of the selected area with white dashed square in (c). d-g) HAADF-STEM image (d) and the corresponding EDS elemental mappings (e-g) of fcc RuMo NFs. h,i) HAADF-STEM (h) and atomic resolution HAADF-STEM (i) images of heterophase hcp/fcc RuMo NFs. Inset of (i): the corresponding FFT pattern of the selected area with white dashed square in (i). j-m) HAADF-STEM image (j) and the corresponding EDS elemental mappings (k-m) of hcp/fcc RuMo NFs.

FIG. 2 depicts X-ray spectral analysis. a) Ru 3p XPS spectra of hcp/fcc Ru NSs, fcc RuMo NFs and hcp/fcc RuMo NFs. b,c) Normalized Ru K-edge XANES (b) and Fourier transform of k²-weighted EXAFS (c) spectra of hcp/fcc Ru NSs, fcc RuMo NFs and hcp/fcc RuMo NFs in reference to Ru foil and RuO₂. d,e) R space (d) and inverse Fourier transform (e) EXAFS fitting results of Ru K-edge for hcp/fcc Ru NSs, fcc RuMo NFs and hcp/fcc RuMo NFs, respectively. f) Wavelet transforms for the k²-weighted Ru K-edge EXAFS spectra of hcp/fcc Ru NSs, fcc RuMo NFs and hcp/fcc RuMo NFs, respectively.

FIG. 3 depicts electrocatalytic NO₃RR performance. a) LSV curves of hcp/fcc Ru NSs, fcc RuMo NFs and hcp/fcc RuMo NFs in 0.1 M KOH with or without (w/o) 100 mM KNO₃. b-d) FE (b), yield rate (c) and half-cell energy efficiency (EE) (d) of NH₃ on hcp/fcc Ru NSs, fcc RuMo NFs and hcp/fcc RuMo NFs under different potentials. e) The NMR spectra of the electrolytes after electrolysis using fcc RuMo NFs at 0 V (vs RHE) without or with K¹⁴NO₃ and K¹⁵NO₃ as the feeding nitrogen sources. f) Comparison of the NH₃ FE and yield rate obtained by UV-vis and NMR methods at 0 V (vs RHE) with K¹⁴NO₃ as the nitrogen source. g) The NH₃ FE and yield rate of fcc RuMo NFs at 0 V (vs RHE) with different nitrate concentrations. h) The consecutive recycling test of fcc RuMo NFs toward NO₃RR at 0 V (vs RHE).

FIG. 4 depicts mechanism investigations of NO₃RR. a,b) Fitting results of double layer capacitance (C_{dl}) (a) and Tafel plots (b) of hcp/fcc Ru NSs, fcc RuMo NFs and hcp/fcc RuMo NFs. c,d) In-situ DEMS patterns of hcp/fcc RuMo NFs (c) and fcc RuMo NFs (d) for NO₃RR. e-g) In-situ DEMS patterns of *NO (e), *N (f) and NH₃ (g) on hcp/fcc Ru NSs, hcp/fcc RuMo NFs and fcc RuMo NFs.

FIG. 5 depicts theoretical calculations of NO₃RR. a-c) The electronic distributions of bonding and anti-bonding orbitals near the Fermi level (E_{F}) in (a) fcc RuMo NFs, (b) hcp/fcc RuMo NFs, and (c) hcp/fcc Ru NSs. Olive balls/light blue balls=Ru and purple balls=Mo. Blue isosurface=bonding orbitals and green isosurface=anti-bonding orbitals. d,e) The PDOSs of (d) fcc RuMo NFs and (e) hcp/fcc RuMo NFs. f), The d-band center of the overall structure and Ru sites in different electrocatalysts. g,h) Site-dependent PDOSs of (g) Ru-4d and (h) Mo-4d orbitals in different electrocatalysts. i) The PDOSs evolutions of key intermediates during NO₃RR. j) The adsorption energy comparisons of NO₃⁻ and *H on different electrocatalysts. k) The reaction energy comparisons of NO₃RR on fcc RuMo NFs, hcp/fcc RuMo NFs, and hcp/fcc Ru NSs. l) The reaction energies of hydrogen evolution on fcc RuMo NFs, hcp/fcc RuMo NFs, and hcp/fcc Ru NSs.

FIG. 6 depicts Zn—NO₃⁻ battery performance. a) The OCV profiles in the rest period of Zn—NO₃⁻ batteries with hcp/fcc Ru NSs, hcp/fcc RuMo NFs and fcc RuMo NFs as the cathode catalyst. Inset: a digital photo of the assembled battery, along with the measurement of OCV. b) Discharging curves and the corresponding power density plots of the assembled Zn—NO₃⁻ batteries with different electrocatalysts. c) Discharging curves of Zn—NO₃⁻ batteries under different current densities. d) The specific capacities of Zn—NO₃⁻ batteries under the current density of 2.5 mA mg_{cat}⁻¹.

FIG. 7 depicts (a,b) Low-magnification TEM images of fcc RuMo alloy NFs.

FIG. 8 depicts a typical side-view HRTEM image of single nanosheet in fcc RuMo NFs.

FIG. 9 depicts high-resolution spherical aberration-corrected HAADF-STEM image of fcc RuMo NFs. Inset: the corresponding FFT pattern of the selected area with the white dashed square.

FIG. 10 depicts XRD pattern of the as-synthesized fcc RuMo NFs, in comparison with those of the standard hcp Ru (JCPDS 06-0663) and fcc Ru (JCPDS 88-2333).

FIG. 11 depicts the EDS spectrum of fcc RuMo NFs. Inset: a table demonstrating the weight ratio and atomic ratio between Ru and Mo.

FIG. 12 depicts (a,b) the HAADF-STEM image (a) and the corresponding EDS line scanning profiles (b) of fcc RuMo NFs.

FIG. 13 depicts (a-c) TEM images and (d) XRD patterns of the products synthesized under (a) 200° C., (b) 210° C. and (c) 220° C.

FIG. 14 depicts (a-e) TEM images and (f) XRD patterns of the products obtained with different amount of glucose: (a) 0 mg, (b) 5 mg, (c) 10 mg, (d) 15 mg and (e) 20 mg.

FIG. 15 depicts (a-e) TEM images and (f) XRD patterns of the products obtained with different amount of salicylic acid: (a) 0 mg, (b) 10 mg, (c) 30 mg, (d) 70 mg and (e) 100 mg.

FIG. 16 depicts low-magnification TEM image of hcp/fcc RuMo alloy NFs.

FIG. 17 depicts a typical side-view HRTEM image of single nanosheet in hcp/fcc RuMo NFs.

FIG. 18 depicts XRD pattern of the as-synthesized hcp/fcc RuMo NFs, in comparison with those of the standard hcp Ru (JCPDS 06-0663) and fcc Ru (JCPDS 88-2333).

FIG. 19 depicts the EDS spectrum of hcp/fcc RuMo NFs. Inset: a table demonstrating the weight ratio and atomic ratio of Ru and Mo.

FIG. 20 depicts (a,b) the HAADF-STEM image (a) and the corresponding EDS line scanning profiles (b) of hcp/fcc RuMo NFs.

FIG. 21 depicts (a-c) TEM images (a,b) and XRD pattern (c) of hcp/fcc Ru NSs.

FIG. 22 depicts (a,b) the Mo 3d XPS spectra of (a) fcc RuMo NFs and (b) hcp/fcc RuMo NFs.

FIG. 23 depicts (a,b) R space (a) and inverse Fourier transform (b) EXAFS fitting results of Ru K-edge for Ru foil.

FIG. 24 depicts the wavelet-transform for the k²-weighted Ru K-edge EXAFS spectrum of Ru foil.

FIG. 25 depicts (a-c) The chronoamperometric curves of (a) hcp/fcc Ru NSs, (b) hcp/fcc RuMo NFs and (c) fcc RuMo NFs in the electrolyte containing 0.1 M KOH and 100 mM KNO₃ at various potentials.

FIG. 26 depicts the UV-vis standard curve of NH₃ with different concentrations of NH₄Cl solutions as standards. (a,b) UV-vis curves of assays with NH₄⁺ ions (a) and linear fitting results of the calibration curves (b).

FIG. 27 depicts the UV-vis standard curve of NO₂⁻ with different concentrations of KNO₂ solutions as standards. (a,b) UV-vis curves of assays with NO₂⁻ ions (a) and linear fitting results of the calibration curves (b).

FIG. 28 depicts the UV-vis calibration curve of N₂H₄ using different concentrations of N₂H₄ solutions as standards. (a,b) UV-vis curves of assays with N₂H₄ (a) and linear fitting results of the calibration curves (b).

FIG. 29 depicts the NH₃ partial current density (j_{NH3}) of hcp/fcc Ru NSs, fcc RuMo NFs and hcp/fcc RuMo NFs at various potentials.

FIG. 30 depicts the NO₂⁻ FE of hcp/fcc Ru NSs, fcc RuMo NFs and hcp/fcc RuMo NFs at various potentials.

FIG. 31 depicts (a,b) the FE (a) and yield rate (b) of N₂H₄ on hcp/fcc Ru NSs, hcp/fcc RuMo NFs and fcc RuMo NFs at various potentials.

FIG. 32 depicts (a,b) the chronoamperometric curves (a) and the yield rates of NH₃ (b) of carbon paper (CP) and fcc RuMo NFs after electrolysis at 0 V (vs RHE) with or without nitrate.

FIG. 33 depicts (a) the ¹H NMR spectra of ¹⁴NH₄⁺ with different ¹⁴NH₄Cl concentrations using C₄H₄O₄ as the internal standard. (b) The calibration curve of integral peak area ratio of ¹⁴NH₄⁺/C₄H₄O₄ against ¹⁴NH₄⁺ concentration.

FIG. 34 depicts (a) the ¹H NMR spectra of ¹⁵NH₄⁺ with different ¹⁵NH₄Cl concentrations using C₄H₄O₄ as the internal standard. (b) The calibration curve of integral peak area ratio of ¹⁵NH₄⁺/C₄H₄O₄ against ¹⁴NH₄⁺ concentration.

FIG. 35 depicts comparison of the NH₃ FE and yield rate obtained by UV-vis and NMR methods at 0 V (vs RHE) with K¹⁵NO₃ as the nitrogen source.

FIG. 36 depicts (a-c) the chronoamperometric curves of fcc RuMo NFs with (a) 10 mM, (b) 40 mM and (c) 70 mM KNO₃ at various potentials.

FIG. 37 depicts (a-e) LSV curves (a), NH₃ FE (b), NH₃ yield rate (c), half-cell energy efficiency of NH₃ (d) and NO₂⁻ FE (e) for fcc RuMo NFs with different KNO₃ concentrations at various potentials.

FIG. 38 depicts the chronoamperometry curves of fcc RuMo NFs during the 20 consecutive electrolysis cycles at 0 V (vs RHE).

FIG. 39 depicts the FE of NO₂⁻ on fcc RuMo NFs during the consecutive electrolysis of 20 cycles at 0 V (vs RHE).

FIG. 40 depicts the overall current density, NH₃ FE and yield evolution for 14 h continuous electrolysis at 0 V (vs RHE).

FIG. 41 depicts TEM image (a), EDS spectrum (b) and SAED pattern (c) of fcc RuMo NFs after the catalytic stability test. Inset of (b): a table demonstrating the weight ratio and atomic ratio between Ru and Mo.

FIG. 42 depicts (a-c) Cyclic voltammetry (CV) profiles of (a) hcp/fcc Ru NSs, (b) hcp/fcc RuMo NFs and (c) fcc RuMo NFs at the sweep rates of 60, 80, 100, 120, 140, 160, 180 and 200 mV s⁻¹.

FIG. 43 depicts in-situ DEMS patterns of hcp/fcc Ru NSs during NO₃RR.

FIG. 44 depicts in-situ DEMS patterns of the detection of (a) *NH and (b) *NH₂ on hcp/fcc Ru NSs, hcp/fcc RuMo NFs and fcc RuMo NFs during NO₃RR.

FIG. 45 depicts Table 1 showing a summary of the Ru K-edge EXAFS fitting results of hcp/fcc Ru NSs, hcp/fcc RuMo NFs, fcc RuMo NFs and Ru foil. Note: Fittings were obtained using k²-weighted R-space spectra with a k-range of 3.0-12 Å⁻¹ and a R-range of 1.0-3.0 Å. R is the interatomic distance (the bond length between center atoms and surrounding coordination atoms); C.N. is the coordination number; σ² is the Debye-Waller factor (a measure of thermal and static disorder in absorber-scatterer distances); ΔE₀ is the edge-energy shift (the difference between the zero kinetic energy value of the sample and that of the theoretical model) used to align the theoretical calculated spectrum to the energy grid of the measured spectrum. The uncertainty of fitting parameters is as follow: C.N., ±20%, R, ±1%; σ², ±20%, ΔE₀, ±20%. R factor is used to evaluate the goodness of the fitting. * These values were fixed during the EXAFS fitting, based on the known structures of Ru foil.

FIG. 46 depicts Table 2 showing a comparison of the electrochemical nitrate reduction performance of unconventional fcc phase RuMo alloy NFs with other reported electrocatalysts.

### DETAILED DESCRIPTION

### Definitions

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a +10%, +7%, +5%, +3%, +1%, or +0% variation from the nominal value unless otherwise indicated or inferred.

The term “substantially crystalline” refers to compositions or compounds with at least 70% by weight, at least 75% by weight, at least 80% by weight, at least 85% by weight, at least 90 by weight, at least 95% by weight, at least 96% by weight, at least 97% by weight, at least 98% by weight, at least 99% by weight, at least 99.5% by weight, or more of the composition or compound is present in crystalline form. The compositions or compounds can exist in a single crystalline form or more than one crystalline form. In certain embodiments, the composition or compound has at least 70% by weight, at least 75% by weight, at least 80% by weight, at least 85% by weight, at least 90 by weight, at least 95% by weight, at least 96% by weight, at least 97% by weight, at least 98% by weight, at least 99% by weight, at least 99.5% by weight, or more of the composition or compound present in a single crystalline form. The degree (%) of crystallinity may be determined by the skilled person using X-ray powder diffraction (XRPD). Other techniques, such as solid-state NMR, FT-IR, Raman spectroscopy, differential scanning calorimetry (DSC) and microcalorimetry, may also be used.

As used herein, the tern “nanoflowers” refers to particles exhibiting a characteristic three-dimensional flowerlike morphology.

Provided herein is a RuMo alloy nanoflower particle comprising a plurality of RuMo nanosheets, wherein the plurality of RuMo nanosheets are in a form of a nanoflower. In certain embodiments, each of the plurality of RuMo nanosheets are substantially crystalline.

In certain embodiments, the plurality of RuMo nanosheets comprise RuMo in a face-centered cubic (fcc) phase or a heterophase comprising a hexagonal close-packed (hcp) phase and a face-centered cubic (fcc) phase.

The RuMo alloy nanoflower particle can range in size between 20-100 nm, 20-90 nm, 20-80 nm, 20-70 nm, 20-60 nm, 20-40 nm, 20-30 nm, 30-100 nm, 40-100 nm, 50-100 nm, 60-100 nm, 70-100 nm, 80-100 nm, 90-100 nm, 30-90 nm, 40-80 nm, 50-70 nm, 60-70 nm, 50-60 nm, 30-70 nm, or 40-60 nm. A plurality of the RuMo alloy nanoflower particles can have an average size between 20-100 nm, 20-90 nm, 20-80 nm, 20-70 nm, 20-60 nm, 20-40 nm, 20-30 nm, 30-100 nm, 40-100 nm, 50-100 nm, 60-100 nm, 70-100 nm, 80-100 nm, 90-100 nm, 30-90 nm, 40-80 nm, 50-70 nm, 60-70 nm, 50-60 nm, 30-70 nm, or 40-60 nm.

Each of the plurality of RuMo nanosheets can have an average thickness of 2.3-3.3 nm, 2.4-3.2 nm, 2.5-3.1 nm, 2.6-3.0 nm, 2.7-2.9 nm, 2.6-3.6 nm, 2.7-3.5 nm, 2.8-3.4 nm, 2.9-3.3 nm, or 3.0-3.2 nm. In instances in which the plurality of RuMo nanosheets comprise RuMo in a face-centered cubic (fcc) phase, each of the plurality of RuMo nanosheets can have an average thickness of 2.3-3.3 nm, 2.4-3.2 nm, 2.5-3.1 nm, 2.6-3.0 nm, 2.7-2.9 nm. In instances in which the plurality of RuMo nanosheets comprise RuMo in a heterophase comprising a hexagonal close-packed (hcp) phase and a face-centered cubic (fcc) phase, each of the plurality of RuMo nanosheets can have an average thickness of 2.6-3.6 nm, 2.7-3.5 nm, 2.8-3.4 nm, 2.9-3.3 nm, or 3.0-3.2 nm.

The atomic ratio of ruthenium to molybdenum in the RuMo alloy nanoflower particle can range from 85:15 to 95:5, 86:14 to 95:5, 87:13 to 95:5, 88:12 to 95:5, 89:11 to 95:5, 90:10 to 95:5, 90:10 to 94:6, 90:10 to 93:7, or 90:10 to 92:8, respectively. In certain embodiments, the atomic ratio of ruthenium to molybdenum in the RuMo alloy nanoflower particle is about 90.9:9.1, respectively. A plurality of the RuMo alloy nanoflower particles can have an average atomic ratio of ruthenium to molybdenum in the plurality of RuMo alloy nanoflower particles from 85:15 to 95:5, 86:14 to 95:5, 87:13 to 95:5, 88:12 to 95:5, 89:11 to 95:5, 90:10 to 95:5, 90:10 to 94:6, 90:10 to 93:7, or 90:10 to 92:8, respectively. In certain embodiments, a plurality of the RuMo alloy nanoflower particles can have an average atomic ratio of ruthenium to molybdenum in the plurality of RuMo alloy nanoflower particles about 90.9:9.1, respectively.

The present disclosure also provides an electrode comprising a base electrode and the RuFe nanoflower particle or a plurality of the RuFe nanoflower particles described herein. In certain embodiments, the RuMo alloy nanoflower particle or the plurality of RuMo alloy nanoflower particles are coated on a surface of the base electrode. The base electrode can be an inert electrode such as a GCE, a graphite electrode, an indium tin oxide (ITO) electrode, a fluorine doped tin oxide (FTO) electrode, carbon paper electrode, carbon fiber electrode, polycarbonate track etch (PCTE)-based electrode, or a titanium-based electrode. In certain embodiments, the electrode is a cathode.

The electrode can optionally comprise a binder. The binder may optionally be cured to further bind the RuFe nanoflower particle or a plurality of the RuFe nanoflower particles with the base electrode and can increase the conductivity of electrode. Typical binders include, for example polyvinylidene fluoride (PVDF), polyvinyl alcohol (PVA), starch, sodium alginate, hydroxypropyl cellulose, carboxymethyl cellulose (CMC), regenerated cellulose, polyvinylpyrrolidone, polyimide, polyamideimide, polyethylene, polypropylene, an ethylene-propylene-diene terpolymer (EPDM), a sulfonated EPDM, a styrene-butadiene rubber, polytetrafluoroethylene (PTFE), a polyacrylic polymer, and combinations thereof. In certain embodiments, the binder is PVA.

The present disclosure also provides an electrochemical cell comprising: the electrode described herein; a counter electrode (or counter/reference electrode); optionally a reference electrode (e.g., in a three-electrode system); and an electrolyte solution between and in contact with the electrode, the counter electrode, and optionally the reference electrode. In certain embodiments, the electrolyte solution comprises an aqueous solution.

A counter electrode refers to an electrode paired with the working electrode, through which passes a current equal in magnitude and opposite in sign to the current passing through the working electrode. The counter electrode can include counter electrodes which also function as reference electrodes (i.e., a counter/reference electrode). Any suitable counter electrode known in the art can be used in connection with the methods described herein. For example, the counter electrode can comprise carbon (e.g., highly oriented pyrolytic graphite), a metal (e.g., platinum), an alloy (e.g., stainless steel), glassy carbon, a conductive polymer, or the like.

The reference electrode can be selected from a standard hydrogen electrode, calomel electrode, copper-copper (II) sulfate electrode, silver chloride electrode, palladium-hydrogen electrode, mercury-mercurous sulfate electrode, and the like.

In certain embodiments, the electrolyte comprises a nitrate salt. The type of nitrate salt is not particularly limited and can be any nitrate salt that is at least partially soluble in the electrolyte solution. The nitrate salt can include one or more cations selected from alkali metals, such as lithium, sodium, potassium, rubidium, and cesium; alkaline earth metals, such as beryllium, magnesium, calcium, strontium, and barium; Group 3-12 transition metals; and NR₄⁺, wherein R is independently for each instance selected from hydrogen and C₁-C₆ alkyl. In certain embodiments, the nitrate salt is selected from the group consisting of LiNO₃, NaNO₃, KNO₃, Ca(NO₃)₂, Mg(NO₃)₂, NH₄NO₃, CsNO₃, and mixtures thereof.

The concentration of the nitrate salt in the electrolyte solution can range from 0.01 to 1 M, 0.01 to 0.9 M, 0.01 to 0.8 M, 0.01 to 0.7 M, 0.01 to 0.6 M, 0.01 to 0.5 M, 0.01 to 0.4 M, 0.01 to 0.3 M, 0.01 to 0.2 M, 0.01 to 0.1 M, 0.04 to 0.1 M, 0.07 to 0.1 M, 0.01 to 0.07 M, 0.01 to 0.04 M, 0.05 to 0.1 M, 0.075 to 0.1 M, 0.01 to 0.075 M, 0.01 to 0.05 M, or 0.05 to 0.75 M.

In certain embodiments, the electrolyte solution further comprises one or more supporting electrolytes. In certain embodiments, the supporting electrolyte is an alkali metal (e.g., lithium, sodium, potassium, rubidium, and cesium), alkaline earth metal (e.g., beryllium, magnesium, calcium, strontium, and barium), or ammonium salt of a halide, acetate, carbonate, perchlorate, phosphate, monohydrogen phosphate, dihydrogen phosphate, or sulfate. Exemplary supporting electrolytes include, but are not limited to, LiClO₄, NaClO₄, KClO₄, Na₂SO₄, K₂SO₄, NaCl, KCl, MgCl₂, NH₄Cl, (NH₄)₂SO₄, Na₃PO₄, K₃PO₄, MgSO₄, Na₂CO₃, K₂CO₃, MgCO₃, NaOH, and KOH.

Also provided herein is a method of producing ammonia gas, the method comprising providing the electrochemical cell described herein, wherein the electrolyte solution comprises a substrate selected from the group consisting of a nitrate salt, a nitrite salt, nitric oxide, nitrogen (N₂), and mixtures thereof; and applying a potential between the electrode and the counter electrode resulting in the electrolytic reduction of the substrate thereby forming ammonia.

The potential applied to the electrode and the counter electrode can range from-0.2 to 1 volts. In certain embodiments, the potential applied to the electrode and the counter electrode can range from −0.2 to 0.9 volts, −0.2 to 0.8 volts, −0.2 to 0.7 volts, −0.2 to 0.6 volts, −0.2 to 0.5 volts, −0.2 to 0.4 volts, −0.2 to 0.3 volts, −0.2 to 0.2 volts, −0.2 to 0.15 volts, −0.2 to 0.1 volts, −0.2 to 0.05 volts, −0.2 to 0.0 volts, −0.2 to −0.05 volts, −0.2 to −0.1 volts, −0.2 to −0.15 volts, −0.2 to 0.2 volts, −0.15 to 0.2 volts, −0.1 to 0.2 volts, −0.05 to 0.2 volts, 0 to 0.2 volts, 0.05 to 0.2 volts, 0.1 to 0.2 volts, 0.15 to 0.2 volts, 0.5 to 0.2 volts, −0.15 to 0.0 volts, −0.1 to 0.0 volts, or −0.05 to 0.0 volts.

The method can have a NH₃ Faradaic efficiency (FE) of 91.7% and 95.2% at −0.1 to 0.0 volts vs reversible hydrogen evolution, respectively.

The RuMo alloy nanoflower particle described herein can be prepared by a solvothermal method comprising: combining Ru₃(CO)₁₂, Mo(CO)₆, glucose, and citric acid or salicylic acid in a solvent comprising oleylamine thereby forming a reaction solution and heating the reaction solution thereby forming the RuMo alloy nanoflower particle.

In certain embodiments, the solvent further comprises a C₆-C₁₂ alkyl alcohol. Exemplary alcohols include n-hexanol, n-heptanol, n-octanol, n-nonanol, n-decanol, n-dodecanol, or the like.

The reaction solution can be heated at a temperature of 150-400° C., 150-350° C., 150-300° C., 150-250° C., or 175-225° C. In certain embodiments, the reaction solution is heated at about 200° C. The reaction solution can be heated for a period of 2 hours to 144 hours, 12 hours to 144 hours, 12 hours to 120 hours, 12 hours to 96 hours, 12 hours to 72 hours, 24 hours to 72 hours, or 30 hours to 54 hours. In certain embodiments, the reaction solution is heated for a period of about 48 hours.

In certain embodiments, the step of heating the reaction solution is conducted under autogenic pressure, i.e., pressure generated as a result of heating in a closed system. Alternatively or additionally, the pressure can be applied externally, e.g., by mechanical means. In certain embodiments, the step of heating the reaction solution is conducted at a pressure of 0.1 to 10 MPa or 0.1 to 1 MPa.

### Synthesis and Structural Characterization

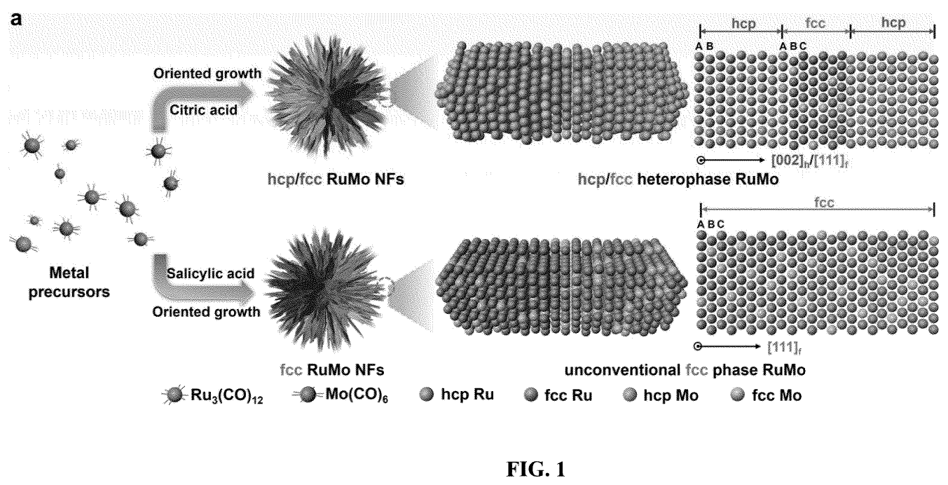

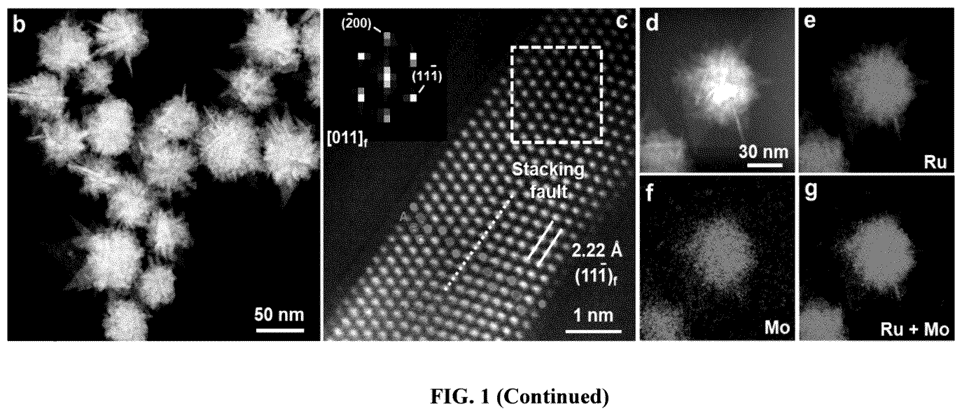

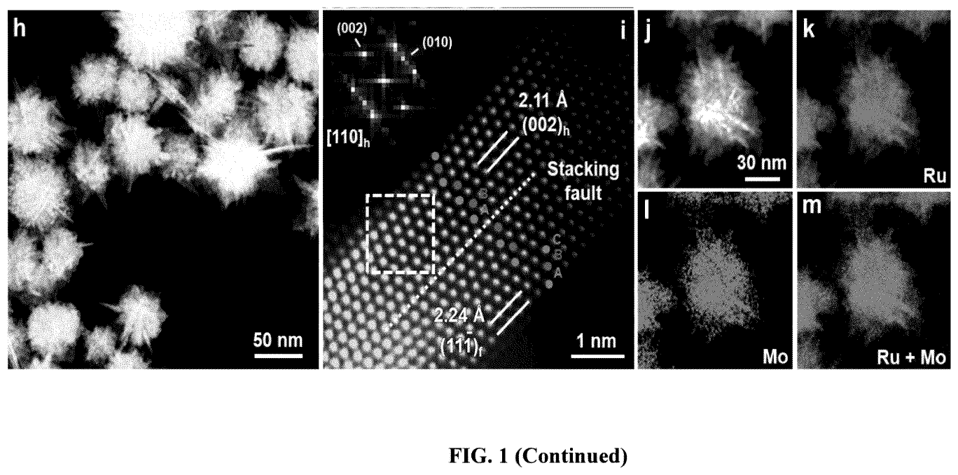

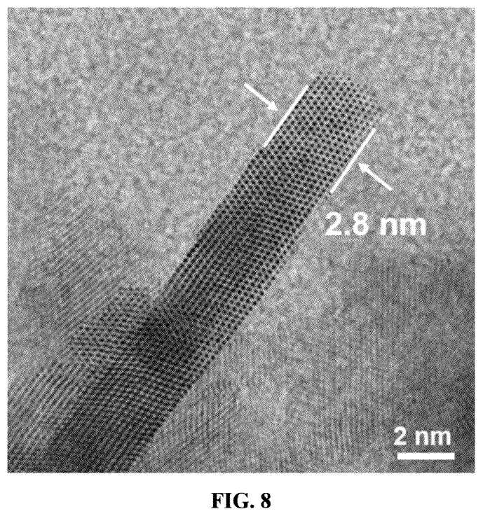

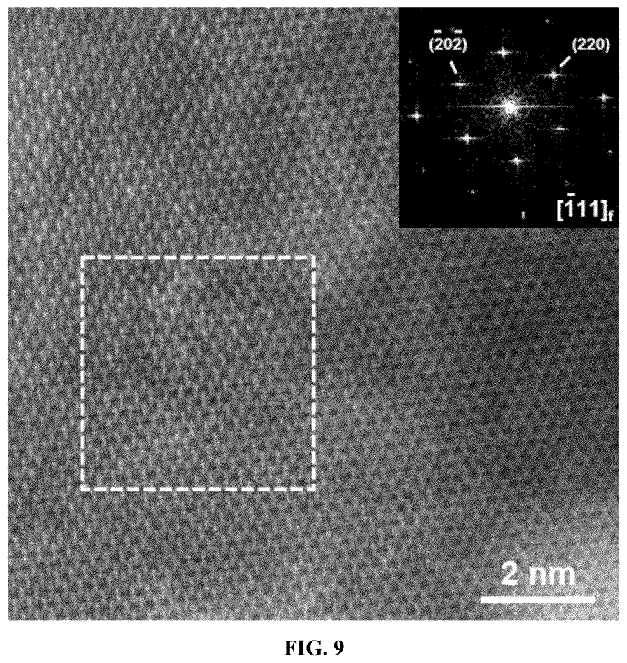

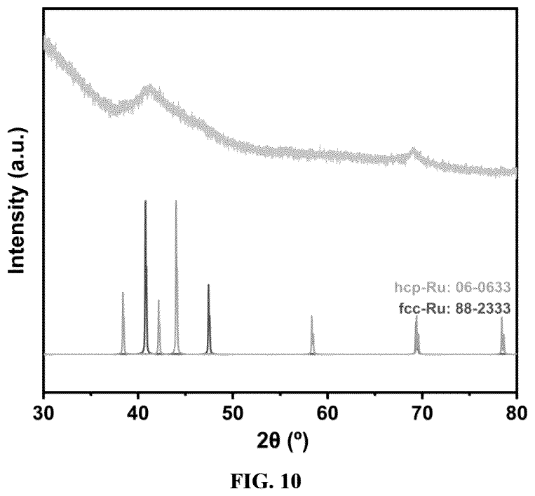

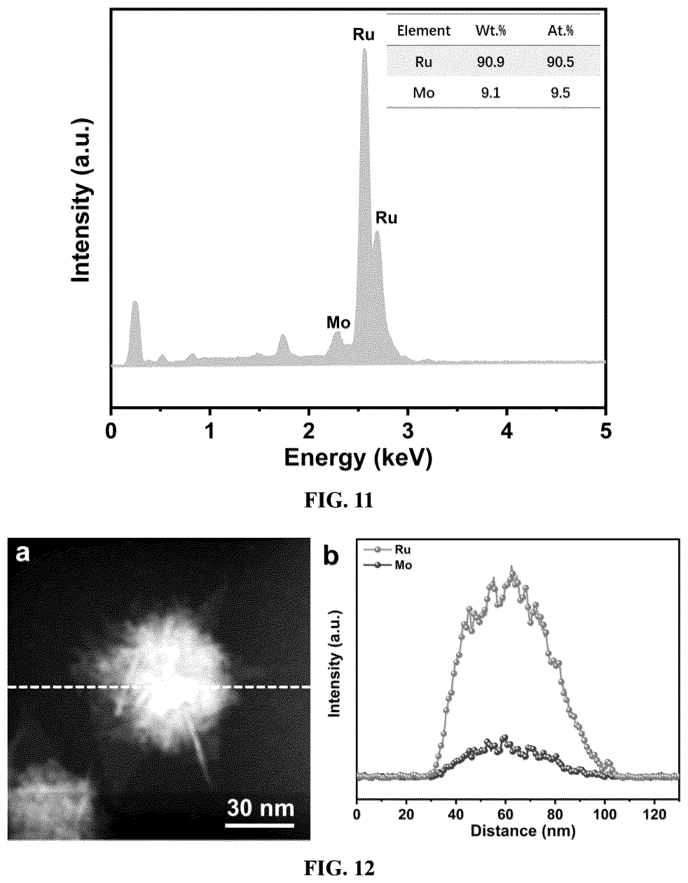

The unconventional fcc phase and hcp/fcc heterophase RuMo alloy NFs were synthesized via a one-pot solvothermal method, as schematically illustrated in FIG. 1a (see details in the Supporting Information). Transmission electron microscopy (TEM) and high-angle annular dark-field scanning TEM (HAADF-STEM) images (FIGS. 1b and 7) show that the three-dimensional (3D) fcc RuMo NFs with a flower-like morphology are assembled by nanosheets with a thickness of about 2.8 nm (FIG. 8). In the atomic-resolution HAADF-STEM image of a typical nanosheet viewed from the [011]^{f} zone axis, a characteristic stacking sequence of fcc phase, i.e., “ABC”, along the close-packed [111]_{f} direction, can be clearly identified (FIG. 1c). An interplanar spacing of 2.22 Å is assigned to the (111̅)_{f} facet of fcc RuMo. The corresponding fast Fourier transform (FFT) pattern of the selected area in FIG. 1c matches well with the electron-diffraction pattern of fcc phase along the [011]_{f} zone axis, indicating the fcc phase of as-synthesized RuMo alloy NFs. Meanwhile, the atomic-resolution HAADF-STEM image of the basal plane of a typical nanosheet and the corresponding FFT pattern of a selected area show a typical crystal structure and electron diffraction pattern from the [1̅11]_{f} zone axis of fcc phase, respectively (FIG. 9). The X-ray diffraction (XRD) pattern further confirms the fcc phase of as-synthesized RuMo NFs (FIG. 10). The energy dispersive X-ray spectroscopy (EDS) result shows that the atomic ratio of Ru/Mo is 90.5/9.5 (FIG. 11). The EDS line scanning and elemental mapping demonstrate the homogenous distribution of Ru and Mo in the resultant fcc RuMo alloy NFs (FIG. 1d-g and FIG. 12).

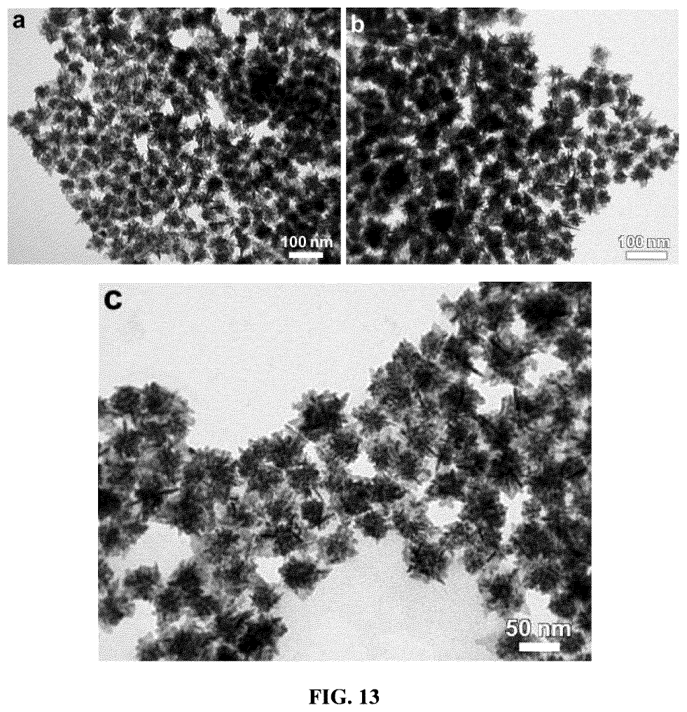

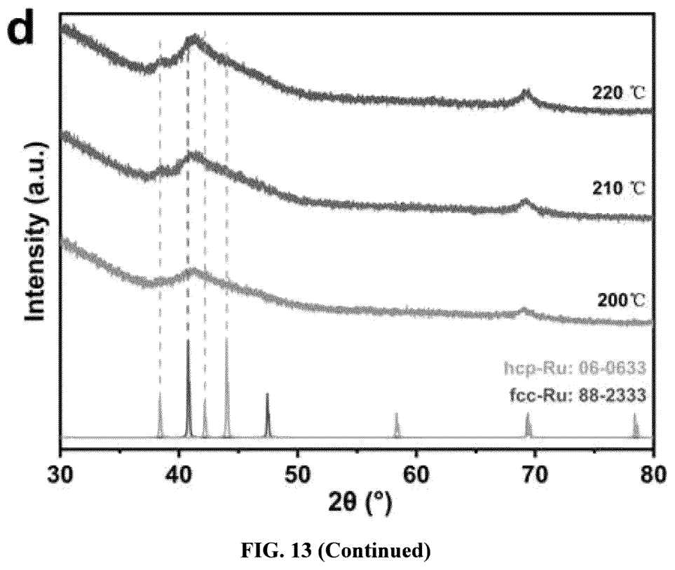

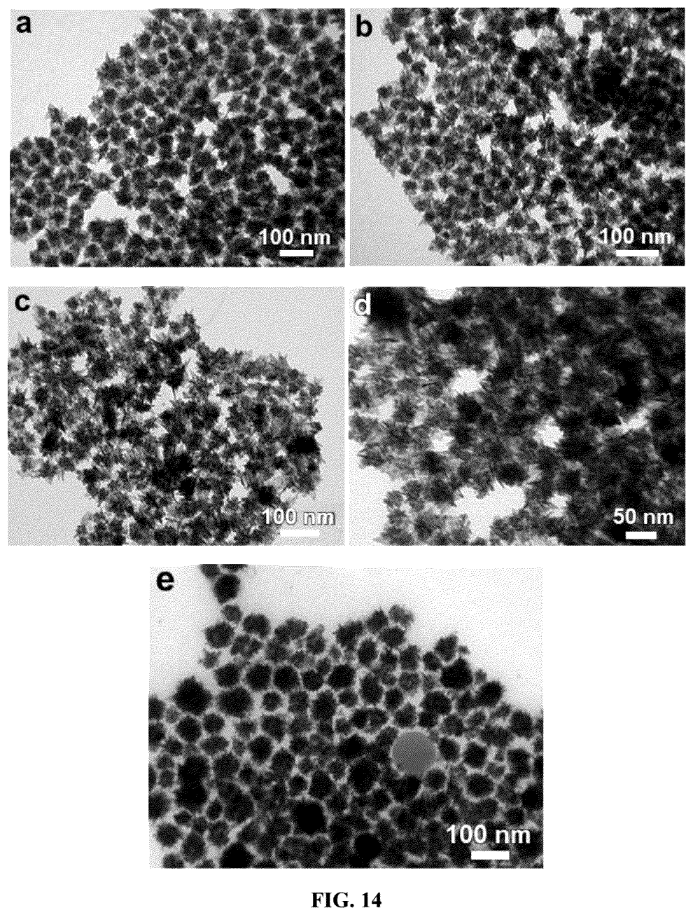

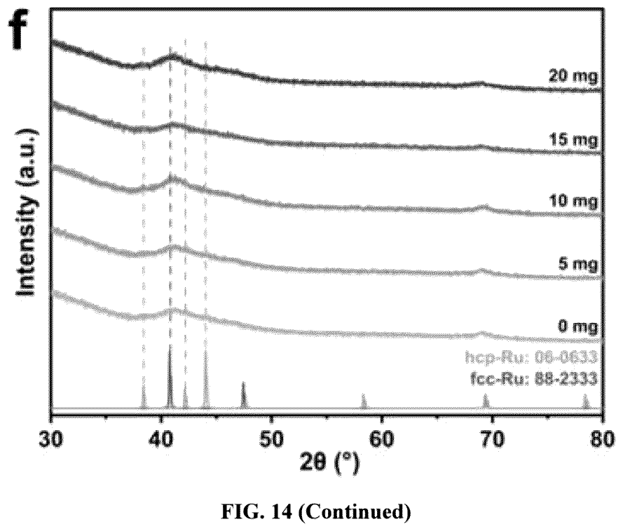

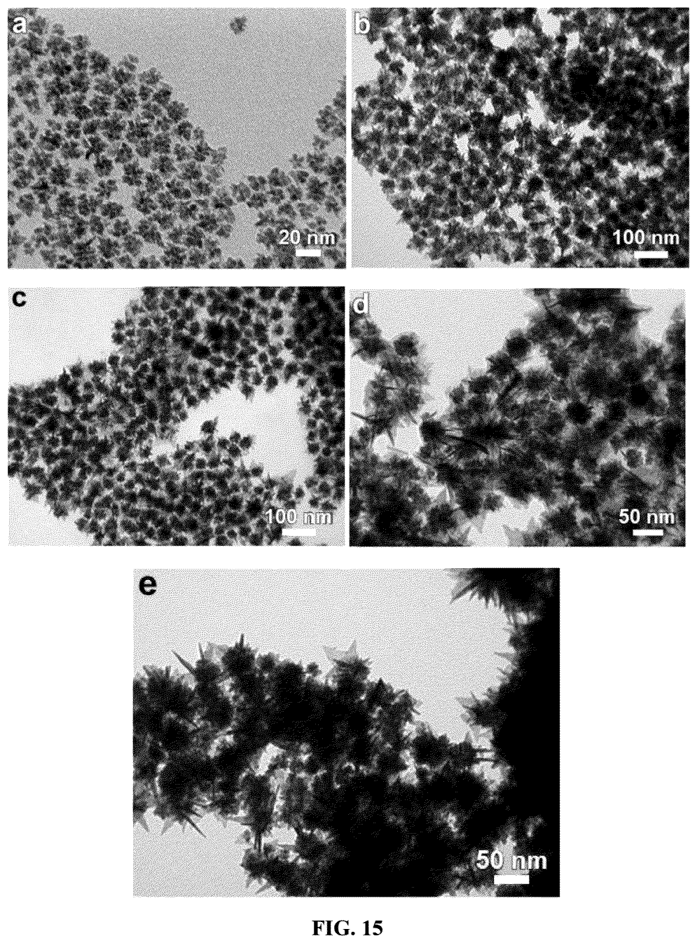

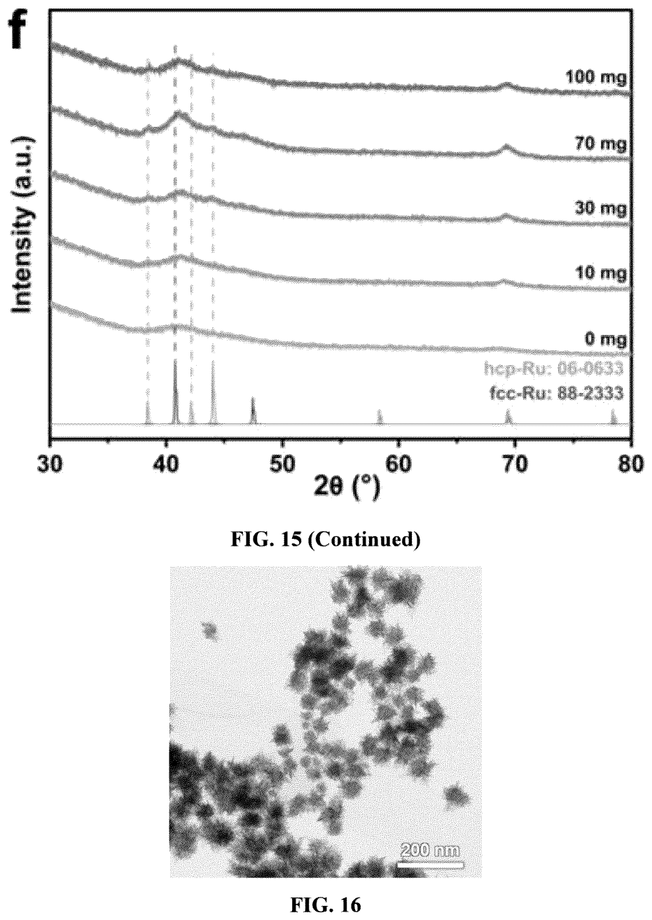

It is worth mentioning that the reaction temperature, dosages of glucose and salicylic acid play a crucial role in the controlled synthesis of fcc RuMo NFs. With increasing the temperature, the morphology of nanoflowers changed a little, while the diffraction peaks ascribed to hcp phase gradually appeared (FIG. 13). Besides, it was found that the morphology and crystal phase of RuMo NFs are significantly affected by the dosage of glucose and salicylic acid. The core of nanoflowers became larger with increasing the amount of glucose or salicylic acid, and simultaneously the diffraction peaks attributed to hcp phase gradually appeared (FIGS. 14 and 15).

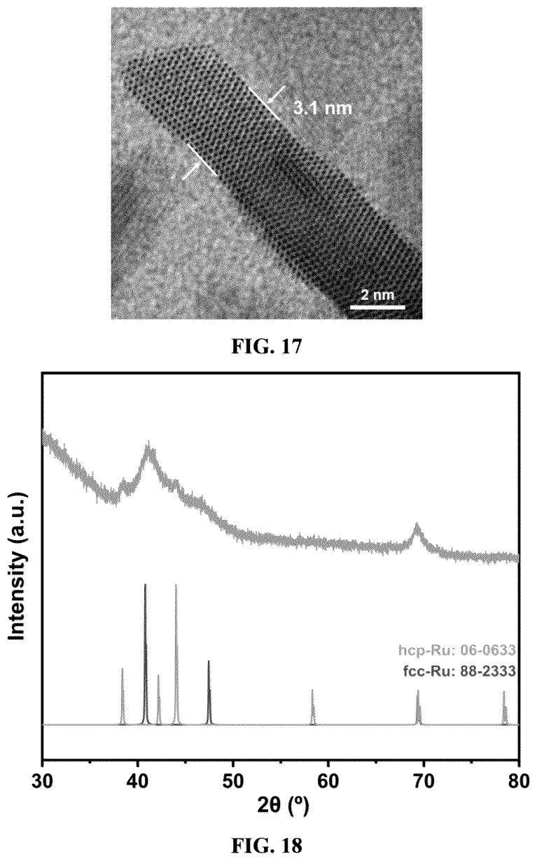

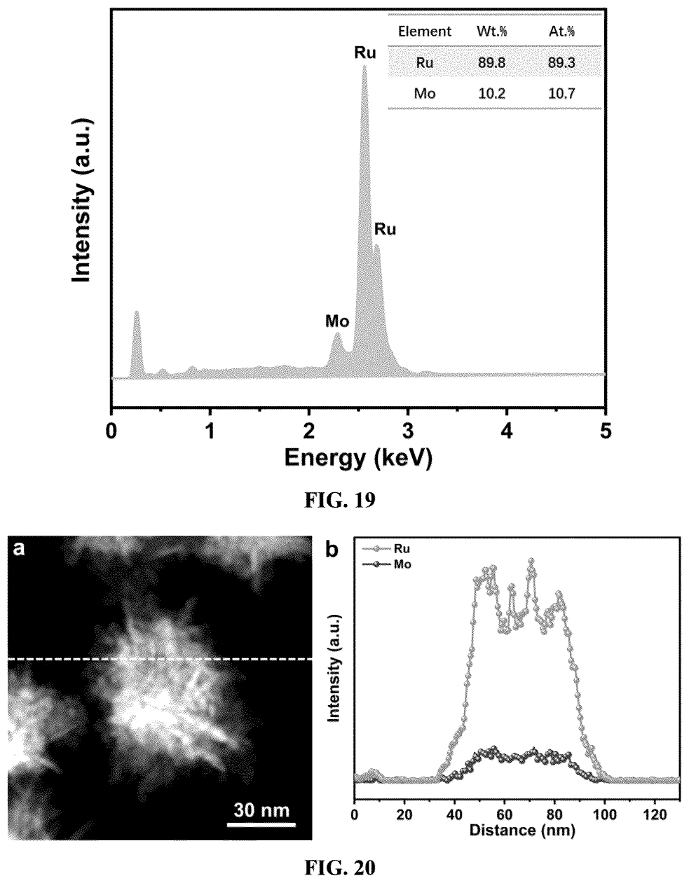

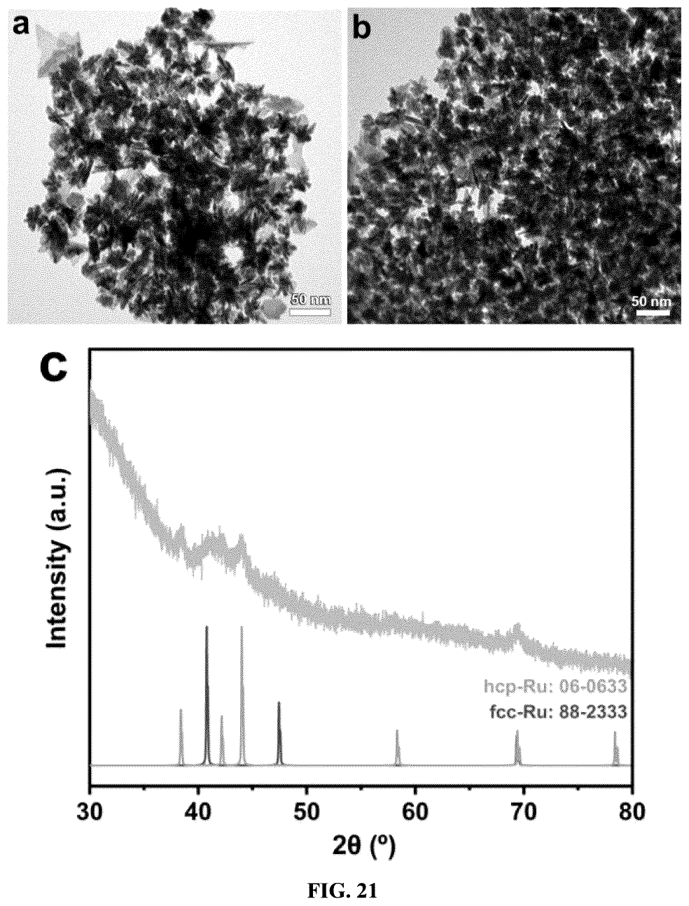

By rationally regulating the reaction conditions, RuMo alloy NFs with unconventional hcp/fcc heterophase were also obtained. TEM and HAADF-STEM images show that the obtained hcp/fcc RuMo NFs are a 3D flower-like structure assembled by nanosheets with a thickness of around 3.1 nm, which is similar to the fcc RuMo NFs (FIGS. 16 and 17, FIG. 1h). The atomic-resolution HAADF-STEM image in FIG. 1i exhibits distinct “AB” and “ABC” stacking sequences along the close-packed [002]ₕ and [111]_{f} directions, respectively, unravelling the hcp/fcc heterophase structure. The lattice spacings of 2.11 Å and 2.24 Å are ascribed to (002)ₕ and (111̅) f facets, respectively. The corresponding FFT pattern of the selected area in FIG. 1i can be assigned to the hop phase viewed from the zone axis of [110]ₕ. The hcp/fcc heterophase of RuMo alloy NFs is also proved by XRD pattern, which contains two sets of diffraction peaks attributed to fcc phase and hcp phase (FIG. 18). The EDS spectrum indicates the Ru/Mo atomic ratio of 89.3/10.7 (FIG. 19), and the EDS line scanning and elemental mapping verify the uniform distribution of Ru and Mo in heterophase hcp/fcc RuMo alloy NFs (FIG. 1j-m and FIG. 20). Besides the unconventional fcc phase and hcp/fcc heterophase RuMo NFs, monometallic Ru nanosheets with hcp/fcc heterophase were also synthesized as a control sample by using a similar method with fcc RuMo NFs except without adding the Mo precursor (FIG. 21).

### X-Ray Spectral Analysis

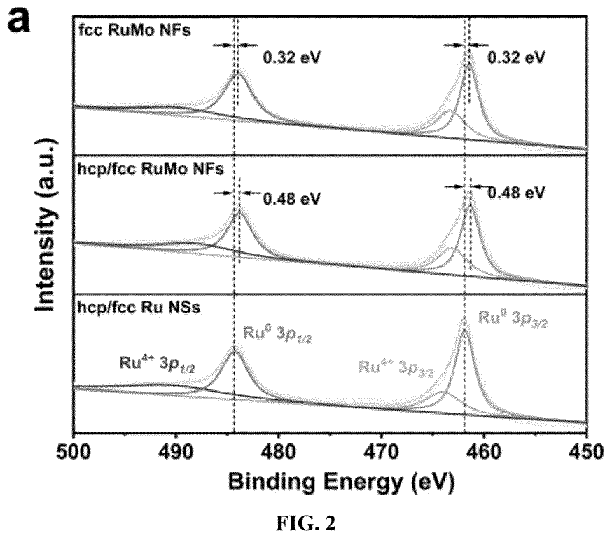

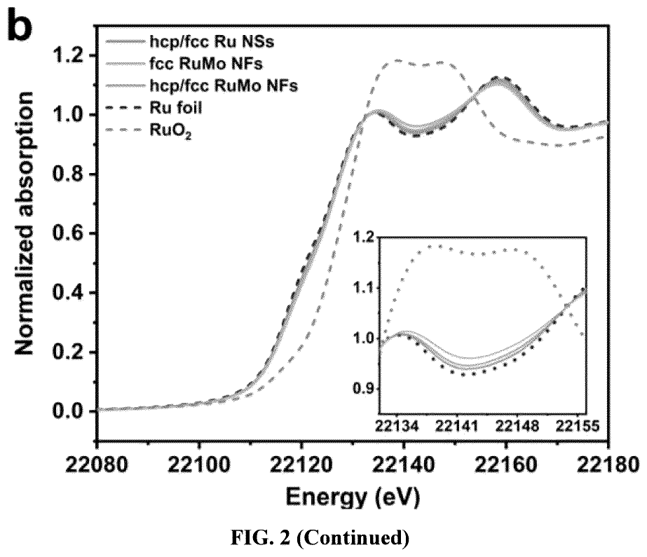

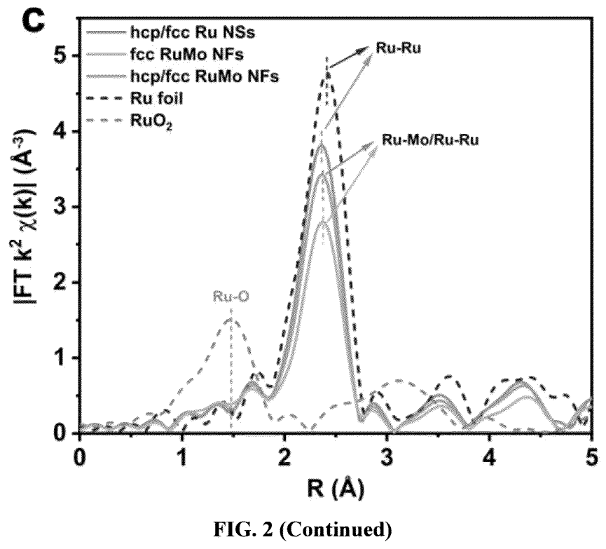

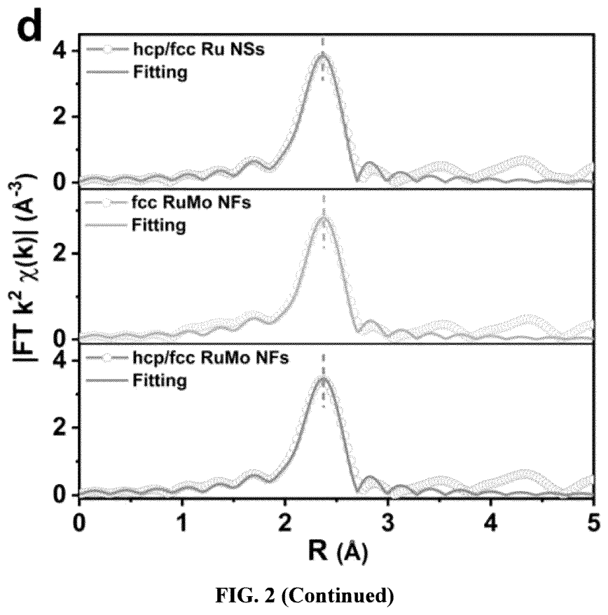

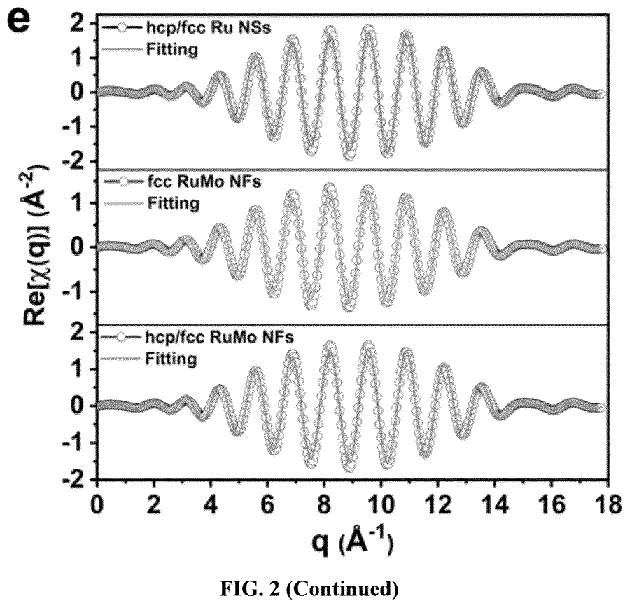

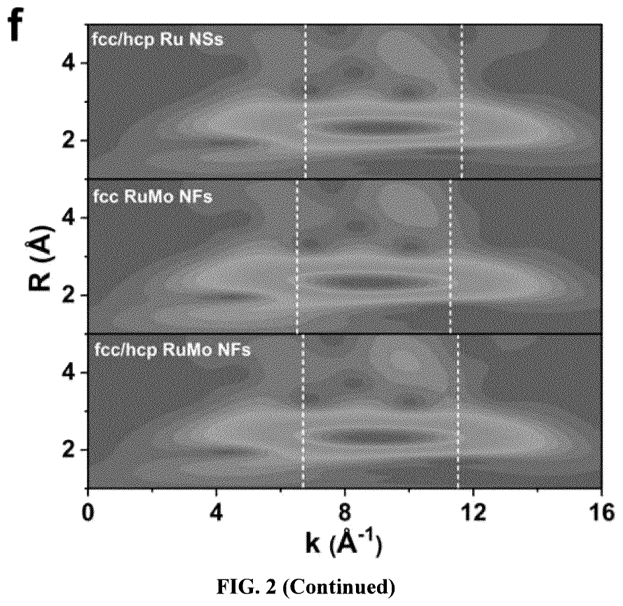

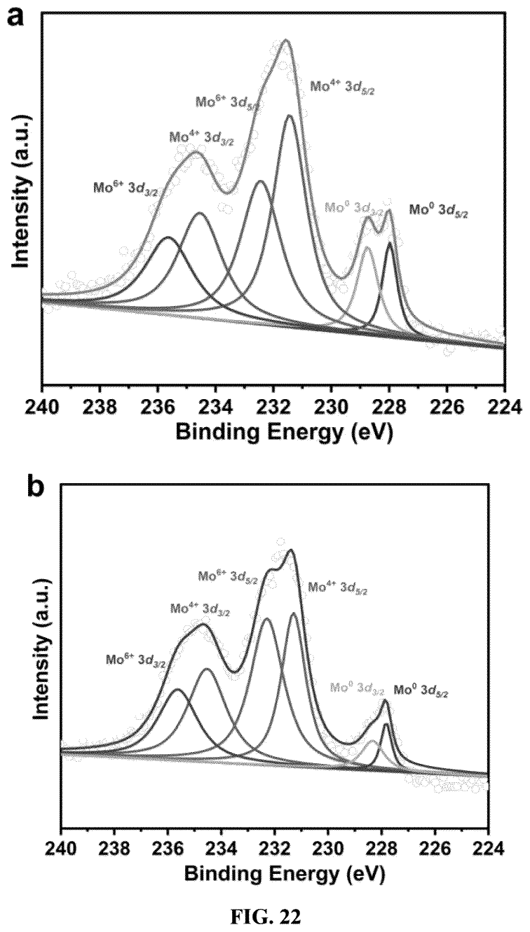

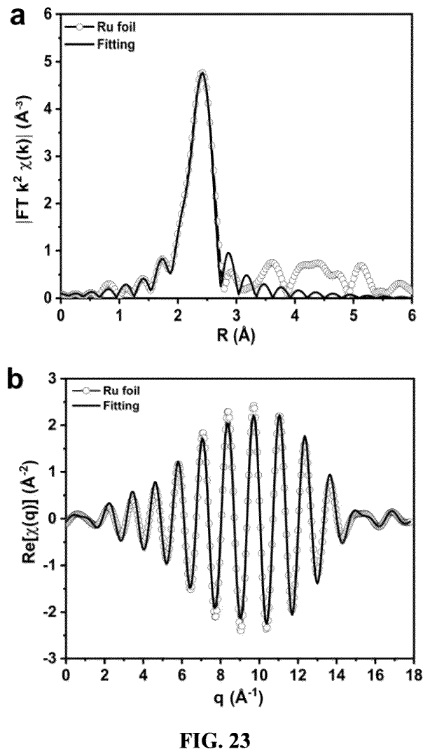

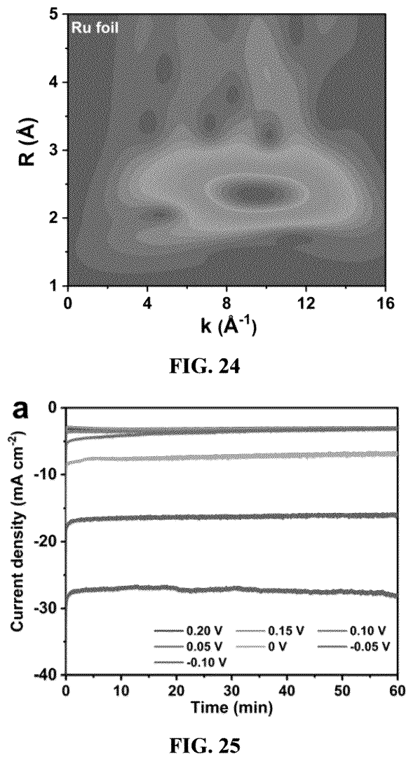

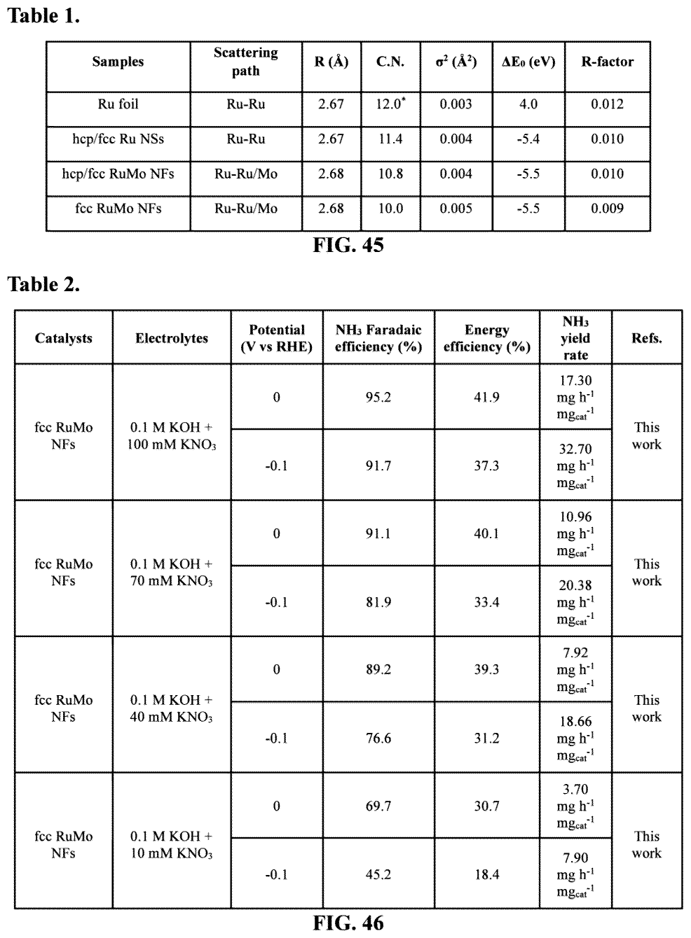

X-ray photoelectron spectroscopy (XPS) was applied to characterize the electronic structures of hcp/fcc Ru NSs, fcc and hcp/fcc RuMo alloy NFs. As shown in FIG. 2a, Ru in three samples mainly adopts the metallic state, along with a slight oxidation due to the inevitable surface oxidation in air. Interestingly, compared with the monometallic hcp/fcc Ru NSs, the peak positions of Ru⁰ in fcc and hcp/fcc RuMo alloy NFs negatively shift by 0.32 eV and 0.48 eV, respectively, which indicates the electron transfer between Ru and Mo. The high-resolution Mo 3d XPS spectra of fcc and hcp/fcc RuMo NFs demonstrate the coexistence of metallic Mo and Mo^{x+} (FIG. 22). Importantly, X-ray absorption spectroscopy (XAS) was utilized to elucidate the electronic structure and local coordination environment of Ru in the obtained samples. FIG. 2b shows the normalized X-ray absorption near-edge structure (XANES) spectra of Ru K-edge. The white line intensities of hcp/fcc Ru NSs, fcc and hcp/fcc RuMo NFs are slightly higher than that of Ru foil, but far lower than that of RuO₂, suggesting Ru mainly exists in the metallic state. Compared with fcc RuMo NFs, the relatively low intensity of hcp/fcc RuMo NFs indicates the high electron density, which is in good agreement with the XPS results. The extended X-ray absorption fine structure (EXAFS) spectroscopies were used to further investigate the local atomic environment of Ru (FIG. 2c-e and FIG. 23). In the k²-weighted R space EXAFS of Ru K-edge, hcp/fcc Ru NSs, fcc and hcp/fcc RuMo alloy NFs show a dominant peak located at about 2.37 Å, which is attributed to Ru—Ru or Ru—Mo scattering paths (FIG. 2c,d). The metallic state of Ru in hcp/fcc Ru NSs, fcc and hcp/fcc RuMo NFs is proved by the absence of Ru—O scattering path in these samples, which is consistent well with the XPS and XANES results. The Ru—Ru/Mo bond distances of both fcc and hcp/fcc RuMo NFs (2.68 Å) are close to those of hcp/fcc Ru NSs (2.67 Å) and Ru foil (2.67 Å), which could be attributed to the similar atomic radii between Ru (1.34 Å) and Mo (1.36 Å). Besides, the coordination number (C.N.) of Ru in fcc RuMo NFs (10.0) is lower than those of hcp/fcc RuMo NFs (10.8) and hcp/fcc Ru NSs (11.4) (Table 1, FIG. 45). The wavelet transform (WT) patterns of hcp/fcc Ru NSs, fcc and hcp/fcc RuMo NFs are close to that of Ru foil (FIG. 2f and FIG. 24), which further identifies the dominant metallic state of Ru in these three samples. Compared with hcp/fcc Ru NSs, the intensity maxima of hcp/fcc RuMo NFs and fcc RuMo NFs demonstrate a slight decrease in the k range but increase in the R range. Moreover, the distribution of maximum intensity of fcc RuMo NFs is narrower than those of hcp/fcc Ru NSs and hcp/fcc RuMo NFs in the k range. These results indicate that the coordination environment of fcc RuMo NFs has been modified due to the introduction of Mo and the formation of unconventional fcc phase.

### Electrochemical NO₃RR Performance

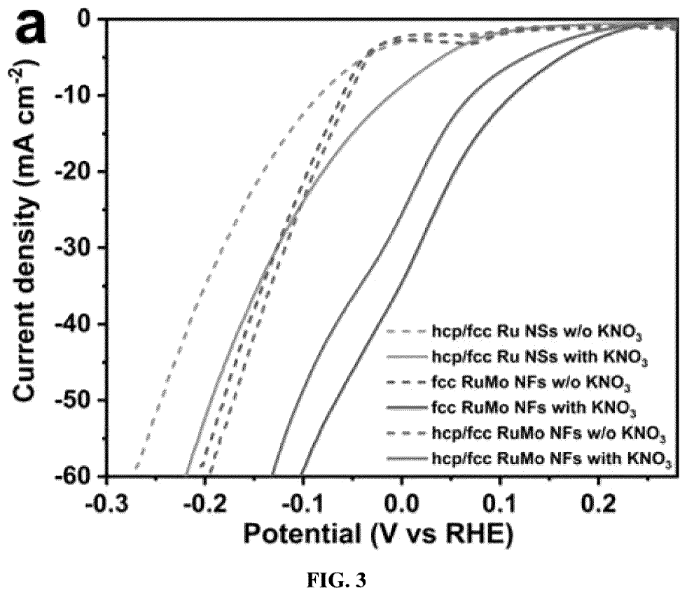

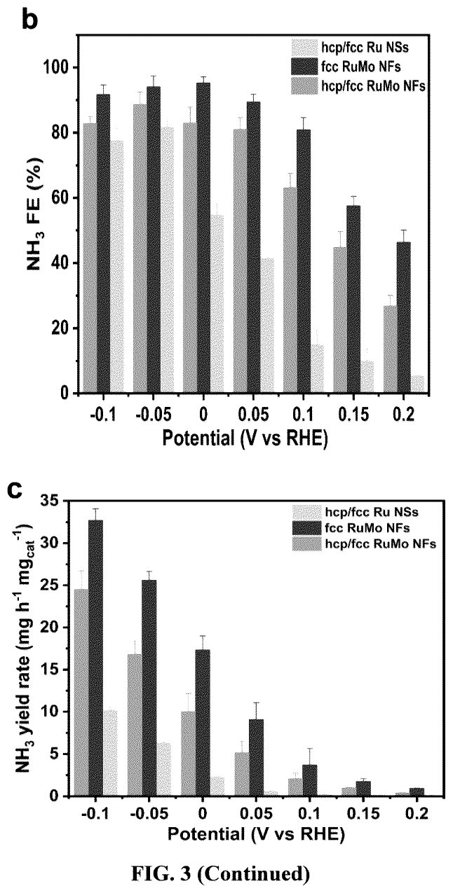

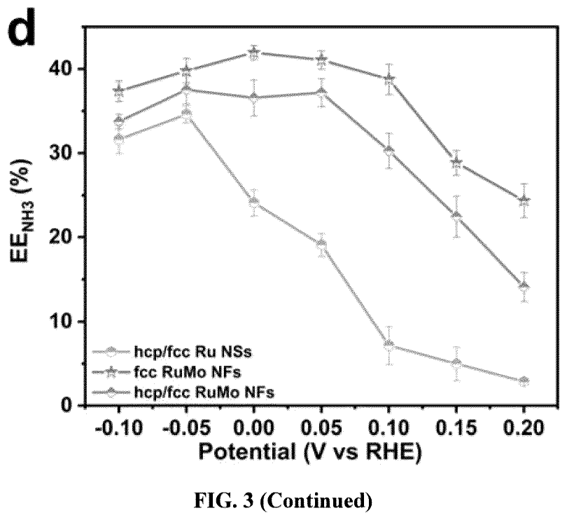

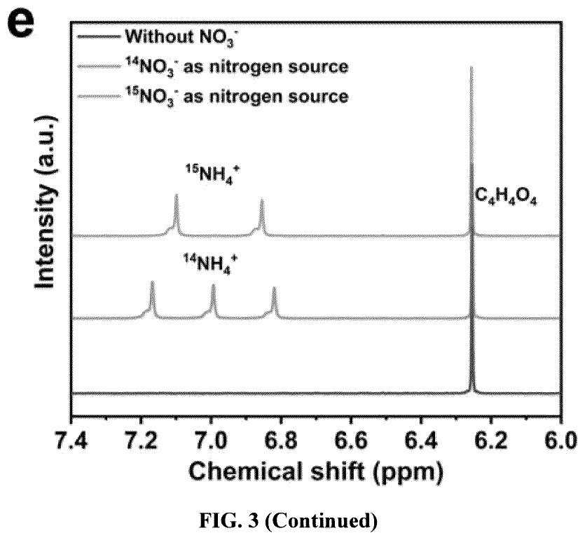

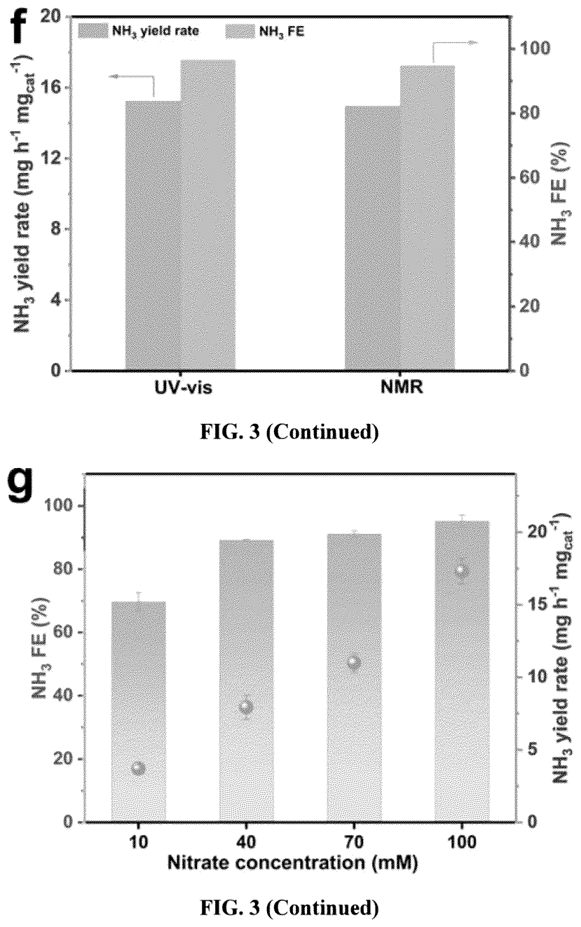

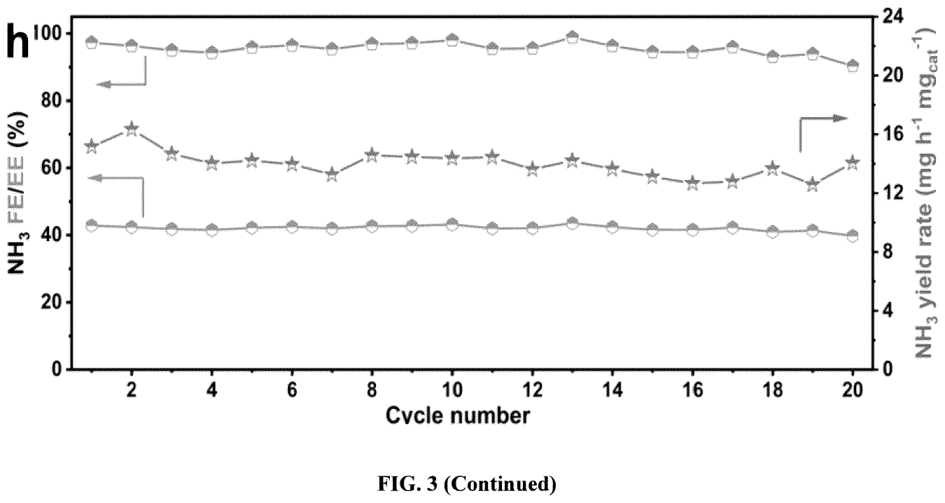

The electrochemical NO₃RR performance of the obtained samples was tested in a standard three-electrode H-type cell under ambient conditions with Ar-saturated electrolyte composed of 0.1 M KOH and 100 mM KNO₃. In the presence of KNO₃, there is a downward hump for fcc and hcp/fcc RuMo alloy NFs at about 0.05 to −0.05 and 0 to −0.1 V (vs RHE), respectively (FIG. 3a), which may be attributed to the mass transfer limited reduction of NO₃⁻. Notably, fcc RuMo NFs demonstrate a more positive onset potential and a larger current density than those of hcp/fcc Ru NSs and hcp/fcc RuMo NFs, suggesting its better catalytic activity toward NO₃RR.

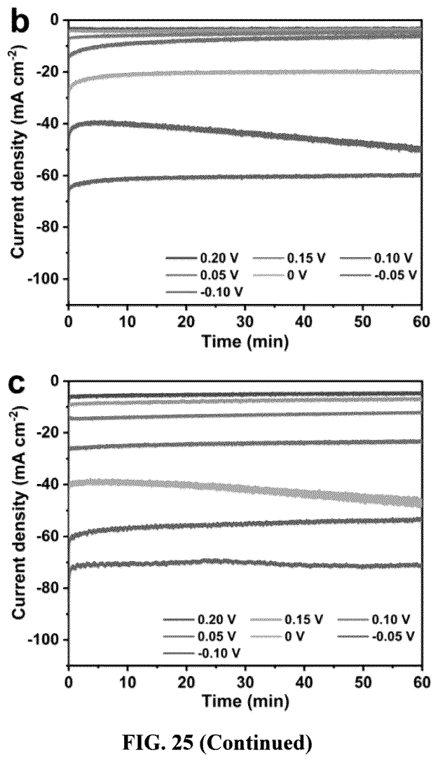

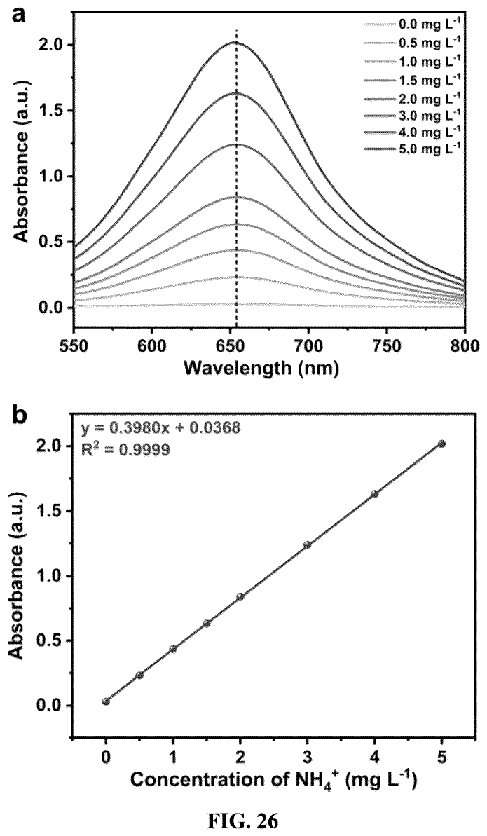

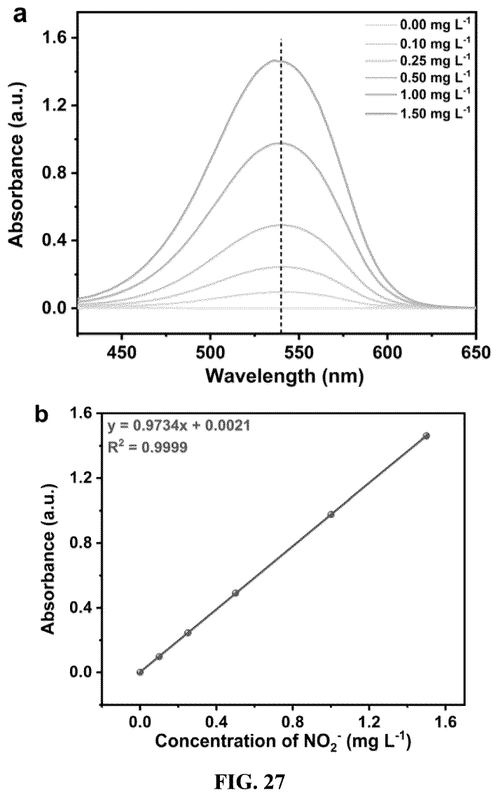

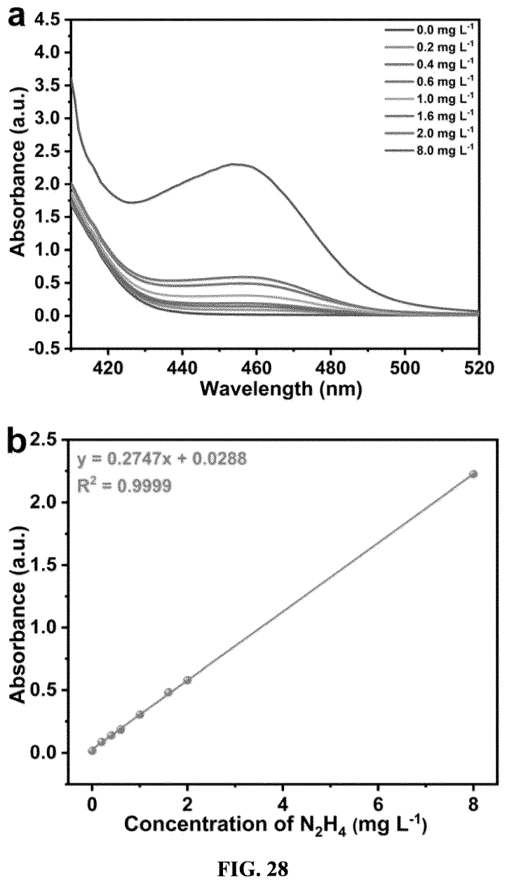

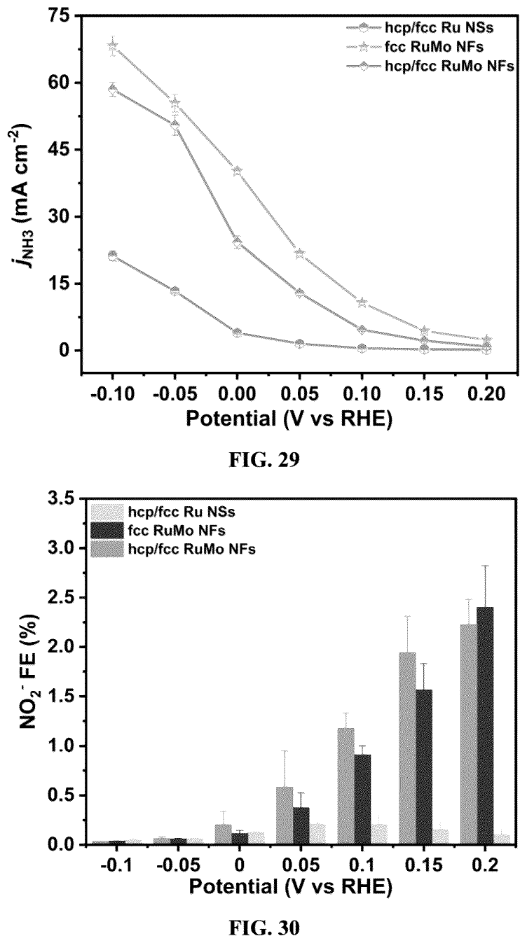

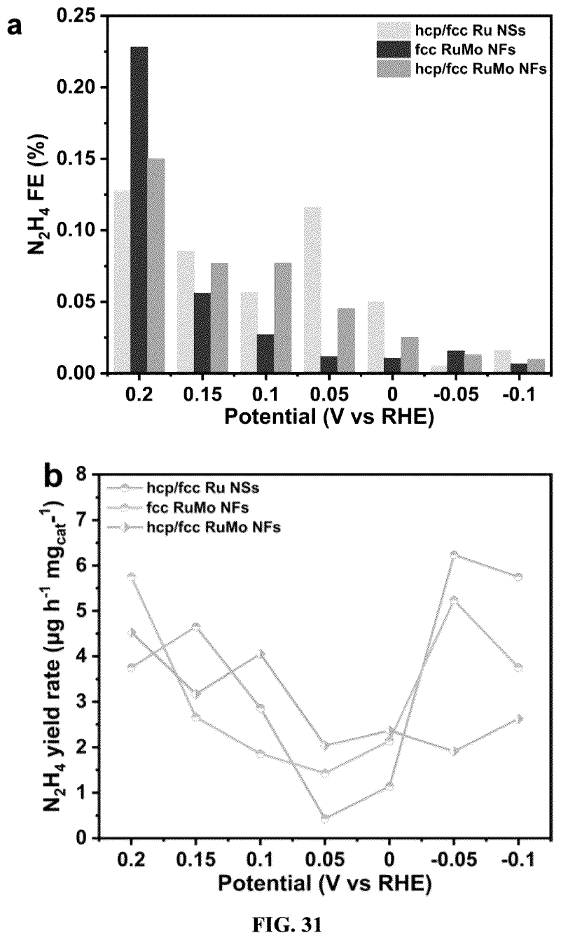

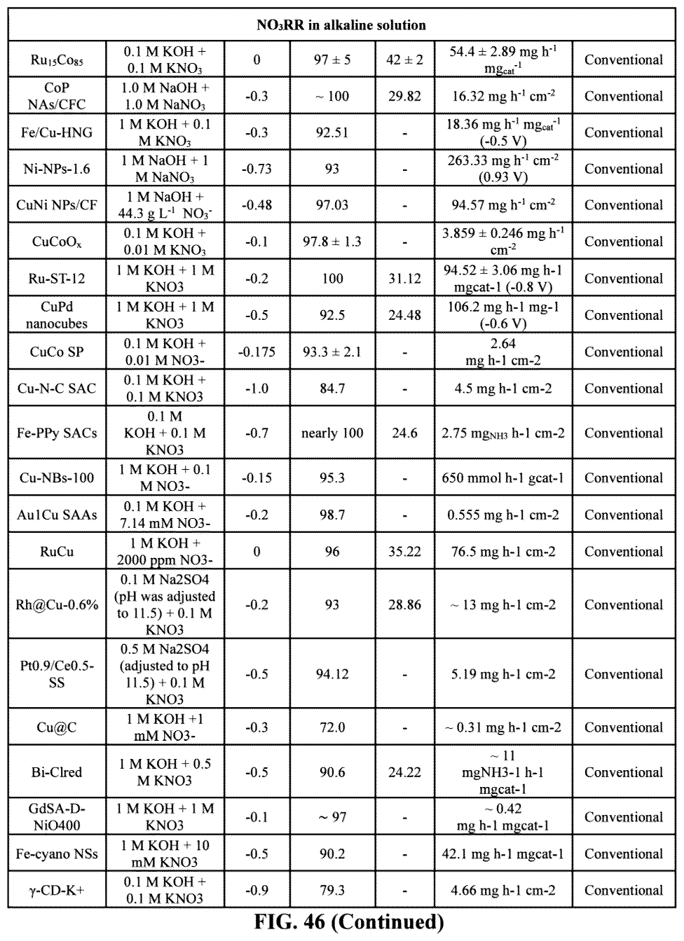

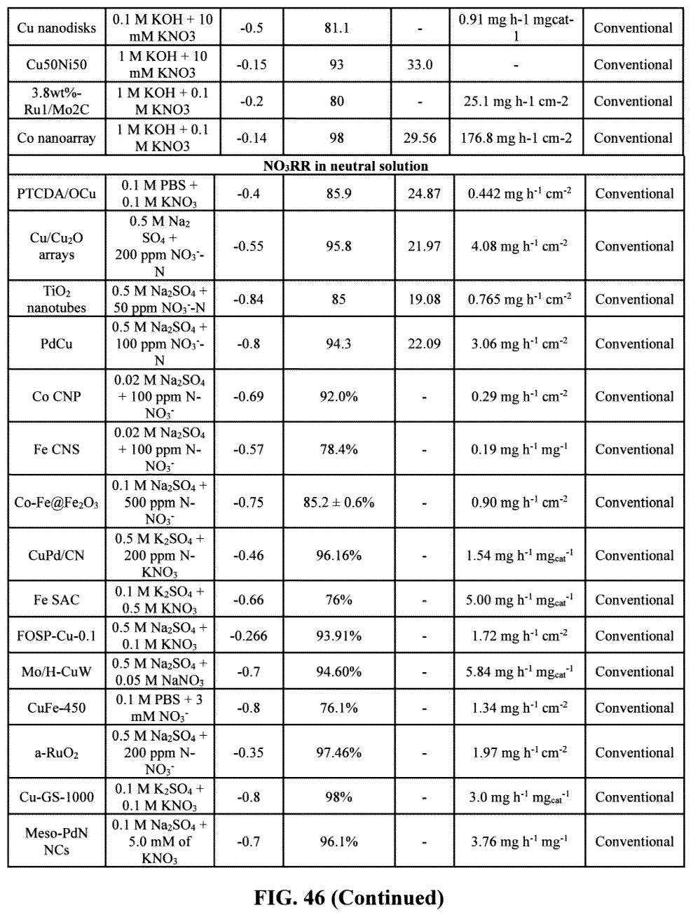

Chronoamperometry measurements were further performed at various potentials to evaluate the NO₃RR performance (FIG. 25). The obtained NH₄⁺, NO₂⁻ and hydrazine (N₂H₄) were detected by the colorimetric methods (FIGS. 26-28). As shown in FIG. 3b, fcc RuMo alloy NFs demonstrate a much higher NH₃ FE than those of hcp/fcc RuMo alloy NFs and hcp/fcc Ru NSs in the whole potential range. The highest NH₃ FE of fcc RuMo NFs is 95.2% at 0 V (vs RHE), while those of hcp/fcc RuMo NFs and hcp/fcc Ru NSs are 88.6% and 81.8% at −0.05 V (vs RHE), respectively. Moreover, the NH₃ FE of fcc RuMo NFs maintains above 90% at a relatively wide potential range from 0.05 to-0.1 V (vs RHE). Impressively, the NH₃ yield rate of fcc RuMo NFs reaches up to 32.7 mg h⁻¹ mg_{cat}⁻¹ at −0.1 V (vs RHE), which is 1.3 and 3.2 times those of hcp/fcc RuMo NFs (24.5 mg h⁻¹ mg_{cat}⁻¹) and hcp/fcc Ru NSs (10.2 mg h⁻¹ mg_{cat}⁻¹), respectively (FIG. 3c). Benefiting from the high NH₃ FE and large NH₃ yield rate, fcc RuMo alloy NFs deliver a much larger partial current density, with a maximum value of 68.3 mA cm⁻² at −0.1 V (vs RHE) (FIG. 29). The half-cell EE of fcc RuMo NFs, hcp/fcc RuMo NFs and hcp/fcc Ru NSs for NH₃ production was also calculated by assuming the overpotential of anodic water oxidation is zero. As shown in FIG. 3d, fcc RuMo NFs achieve the highest EE among three samples in the whole potential range, with the highest EE of 41.9%. In addition, NO₂⁻ and N₂H₄ are usually formed as byproducts during NO₃RR. It was found that FE of NO₂⁻ is below 3% over hcp/fcc Ru NSs, fcc and hcp/fcc RuMo NFs (FIG. 30). The FE of N₂H₄ is lower than 0.25% and the yield rate is below 7 μg h⁻¹ mg_{cat}⁻¹ (FIG. 31). The above results demonstrate that fcc RuMo alloy NFs possess excellent catalytic performance toward NO₃RR in terms of NH₃ FE, yield rate and EE, surpassing most of the reported metal-based catalysts (Table 2, FIG. 46).

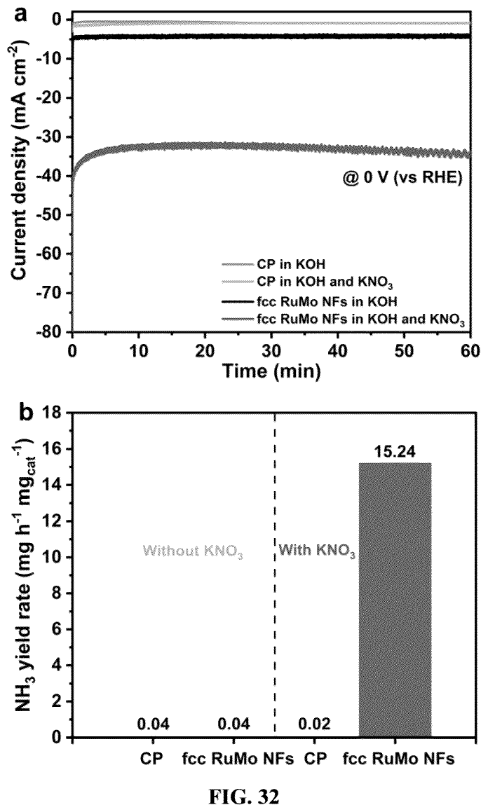

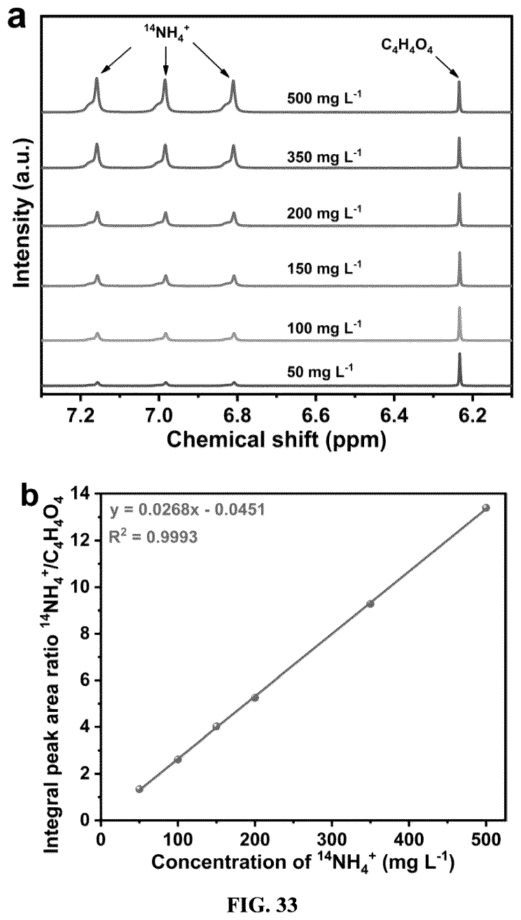

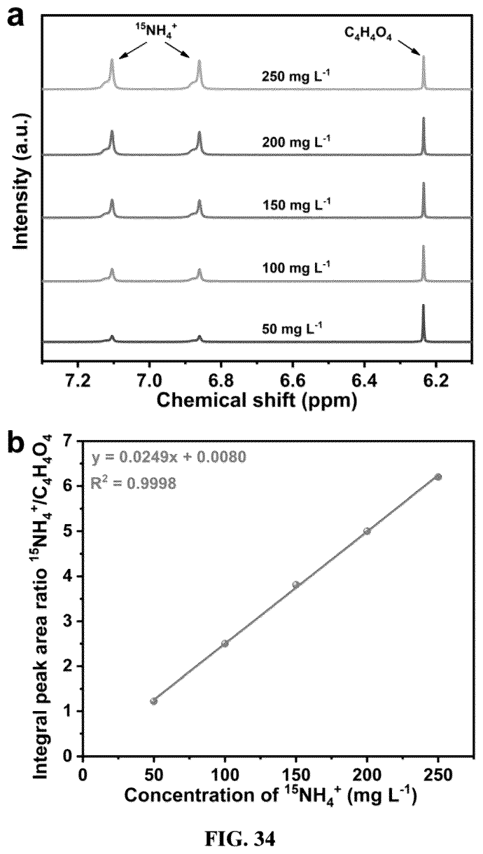

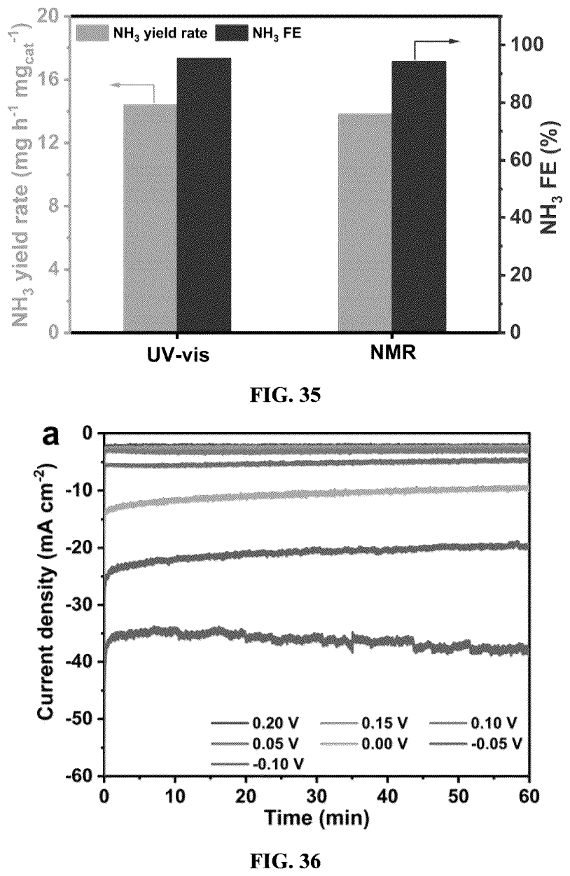

To confirm the origin of the nitrogen source and the accuracy of NO₃RR performance test, control experiments were conducted. The current density and NH₃ yield rate of bare carbon paper (CP) show a negligible change after adding KNO₃, suggesting the inertness of CP toward electrocatalytic NO₃RR. In contrast, compared with the pure KOH, the current density and NH₃ yield rate of fcc RuMo alloy NFs increase a lot in the presence of KNO₃ (FIG. 32). Meanwhile, isotope labelling experiments were also performed. Nuclear magnetic resonance (NMR) measurements show that characteristic triple and double peaks ascribed to ¹⁴NH₄⁺ and¹⁵NH₄⁺ are detected by using ¹⁴NO₃⁻ and ¹⁵NO₃⁻ as the feeding nitrate sources (FIG. 3e), respectively, which verifies that the obtained NH₃ does originate from the feeding nitrate. Importantly, with K¹⁴NO₃ or K¹⁵NO₃ as the nitrogen source, the NH₃ FE and yield rate acquired by ultraviolet-visible (UV-vis) approach is in good agreement with those collected by NMR method (FIG. 3f and FIGS. 33-35), indicating the good accuracy and high reliability of the obtained results.

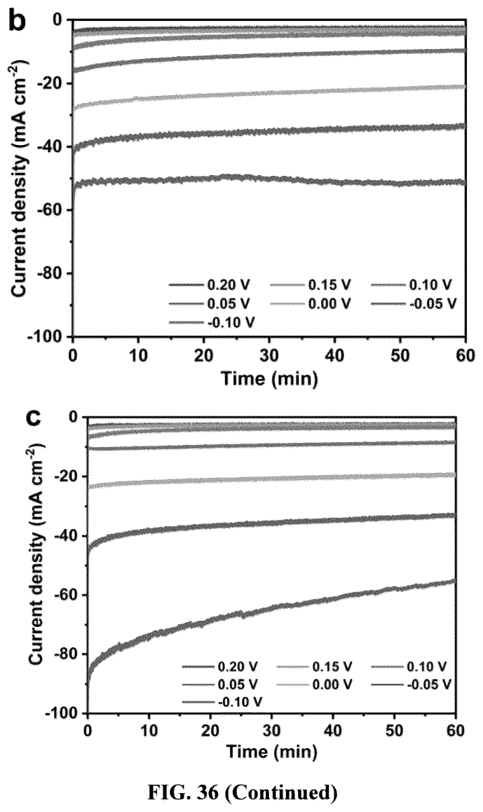

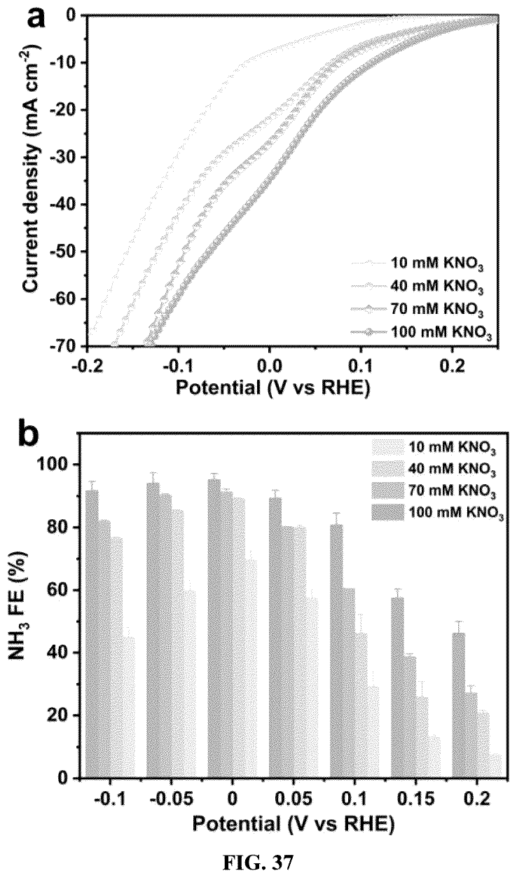

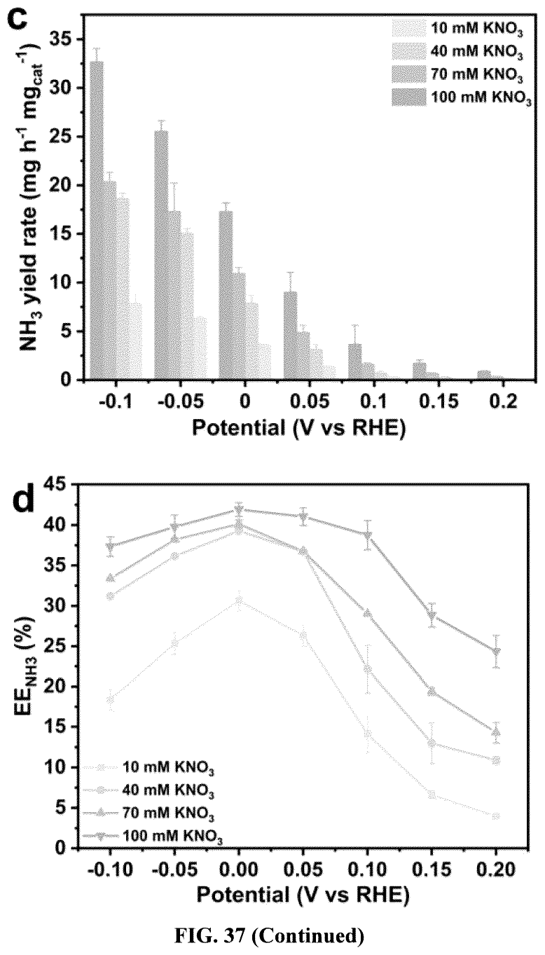

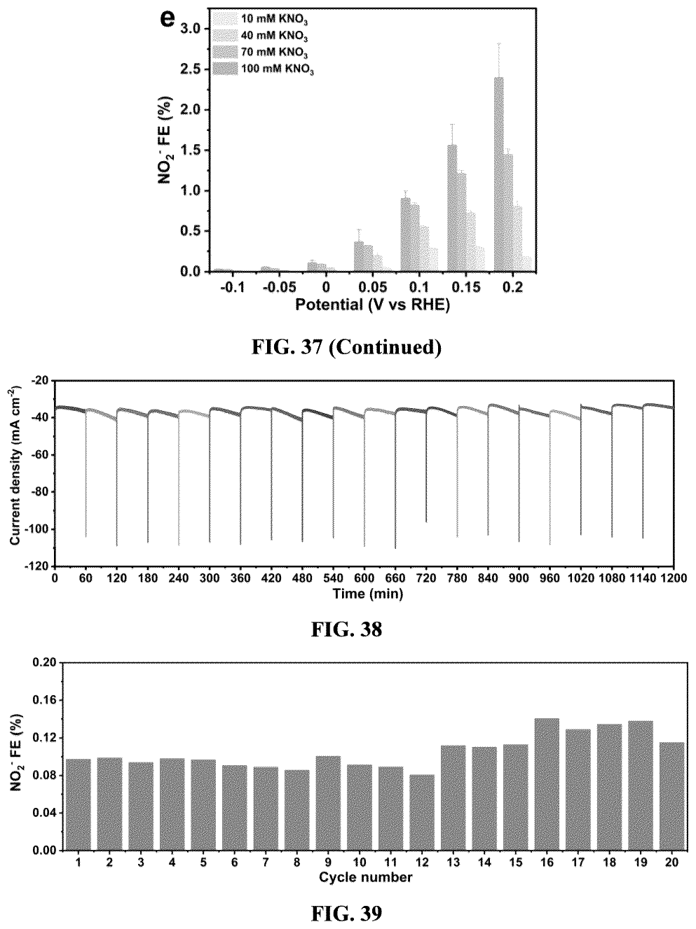

The influence of NO₃⁻ concentration on the NO₃RR performance was also investigated using fcc RuMo alloy NFs (FIGS. 36 and 37). With decreasing the NO₃⁻ concentration from 100 to 40 mM, the highest NH₃ FE only shows a slight decrease from 95.2% to 89.2%. When the NO₃⁻ concentration decreases to 10 mM, the NH₃ FE, yield rate and half-cell energy efficiency of fcc RuMo NFs reduce obviously, but they can still maintain the highest FE and EE of 69.7% and 30.7% at 0 V (vs RHE) (FIG. 3g and FIG. 37b,d), respectively, and achieve the largest NH₃ yield rate of 7.90 mg h⁻¹ mg_{cat}⁻¹ at −0.1 V (vs RHE) (FIG. 37c), demonstrating promising application potential for NH₃ production toward practical wastewater with low NO₃⁻ concentration. As for the by-product, the FE of NO₂⁻ decreases with reducing the NO₃⁻ concentration (FIG. 37e), which may be attributed to the fast hydrogenation rate of NO₂⁻ to NH₃ resulting from the sufficient active hydrogen supply under low NO₃⁻ concentration.

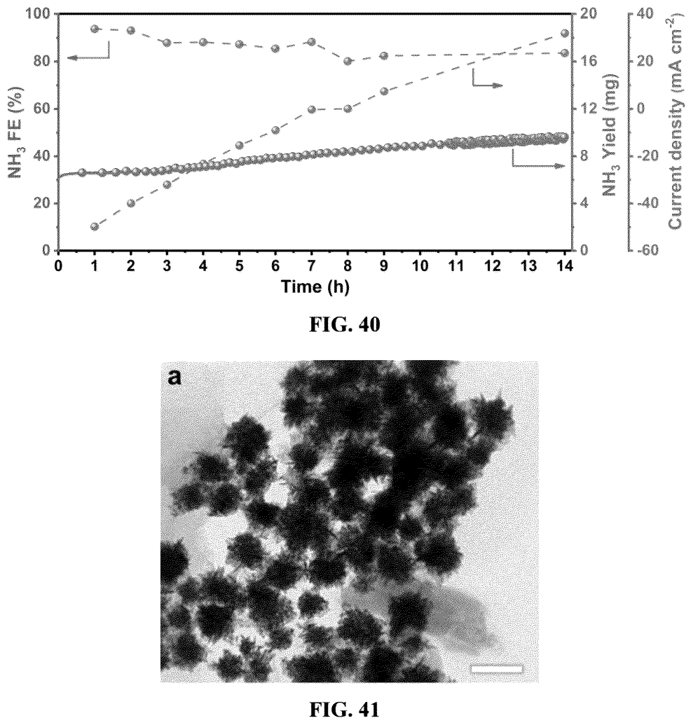

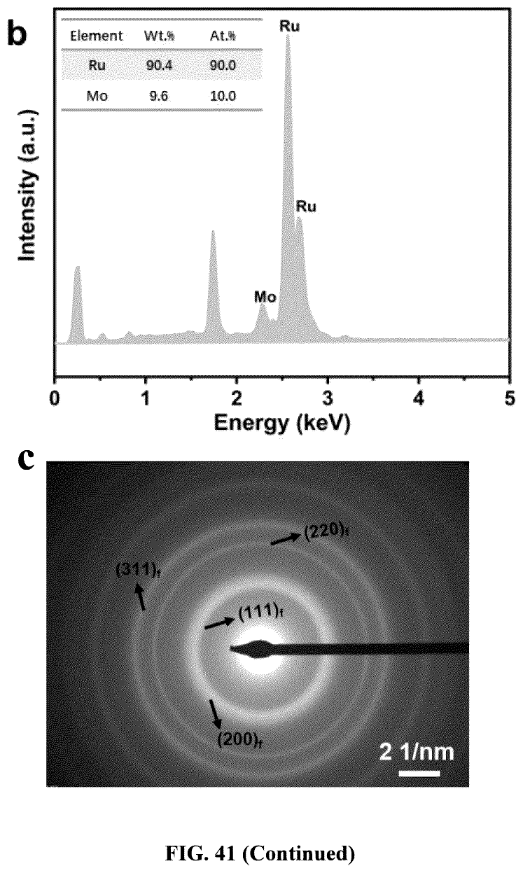

The catalytic stability of fcc RuMo alloy NFs was evaluated by the consecutive electrolysis cycles and long-term chronoamperometry test. During the 20 consecutive electrolysis cycles at 0 V (vs RHE), no obvious changes of the current density were observed from the chronoamperometry curves (FIG. 38), and the NH₃ FE and yield rate kept relatively stable (FIG. 3h). Meanwhile, the NO₂⁻ FE still maintained at an ultralow level of below 1% (FIG. 39). During the long-term chronoamperometry test, the NH₃ FE and current density only showed a little decrease during the 14 h electrolysis, and the amount of formed NH₃ kept almost linearly increase (FIG. 40). Notably, the morphology, composition and crystal phase of fcc RuMo alloy NFs can be well preserved after the consecutive electrolysis, which is verified by the TEM, EDS and selected-area electron diffraction (SAED) results (FIG. 41).

### Mechanism Investigation

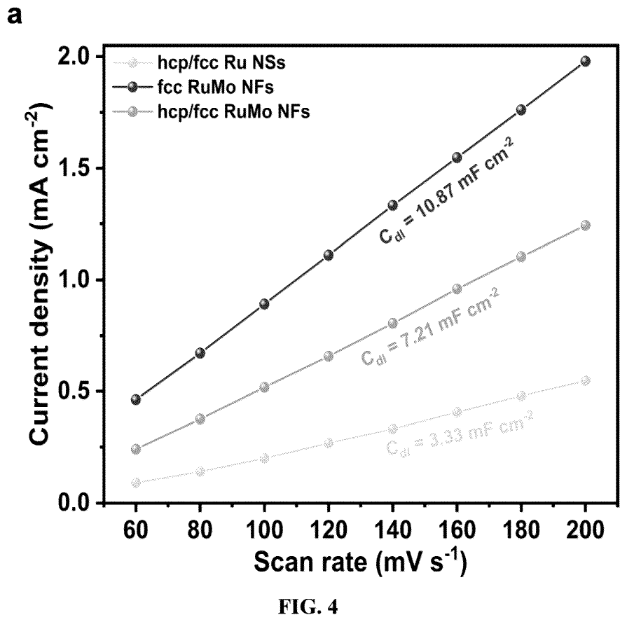

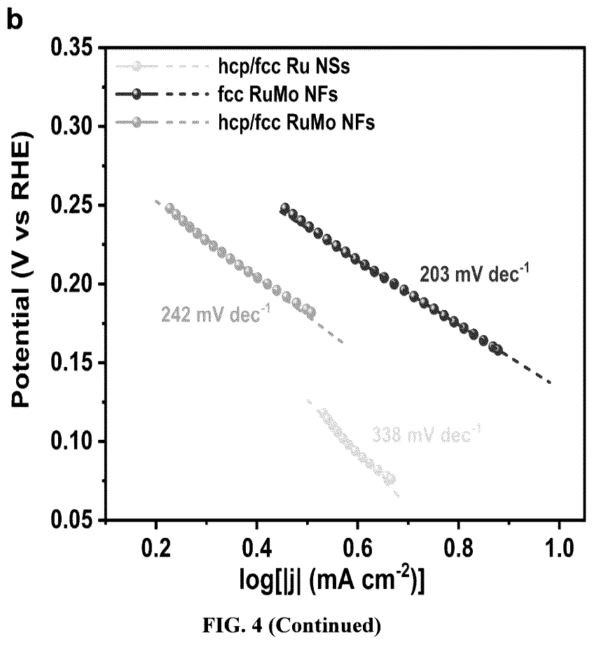

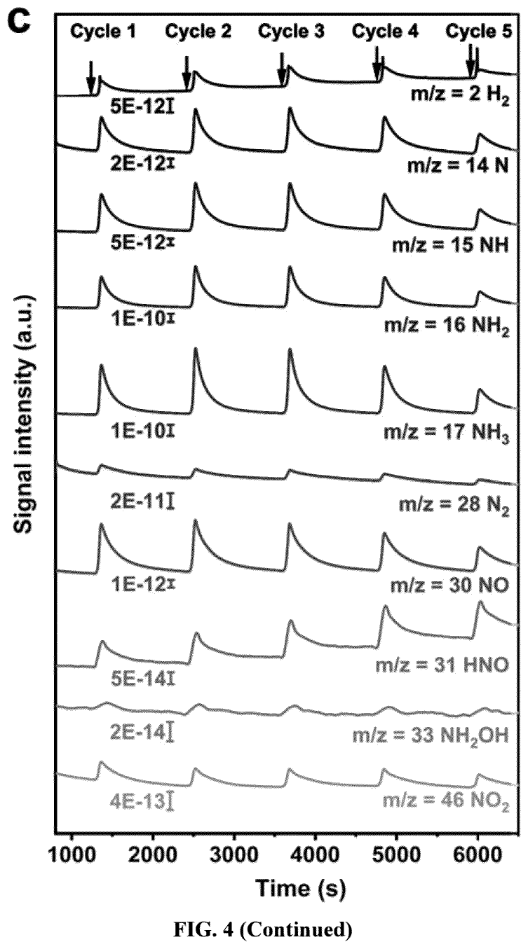

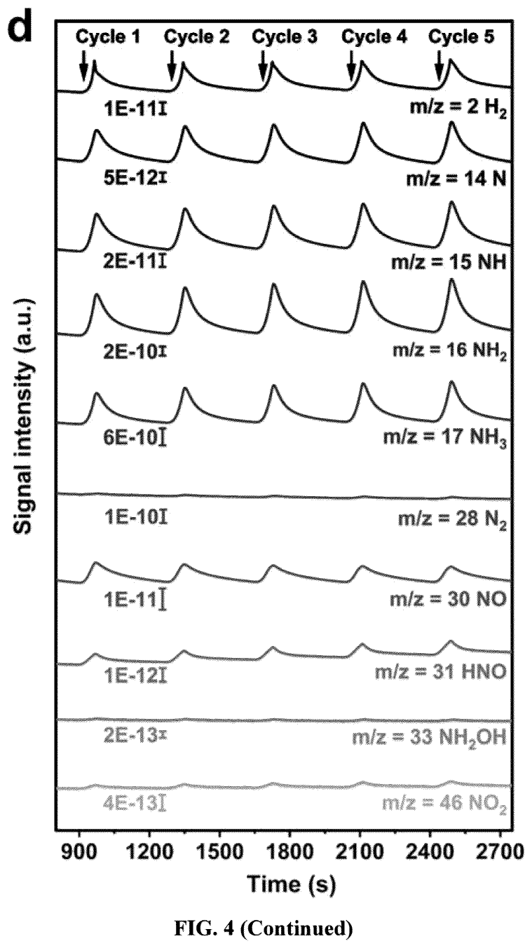

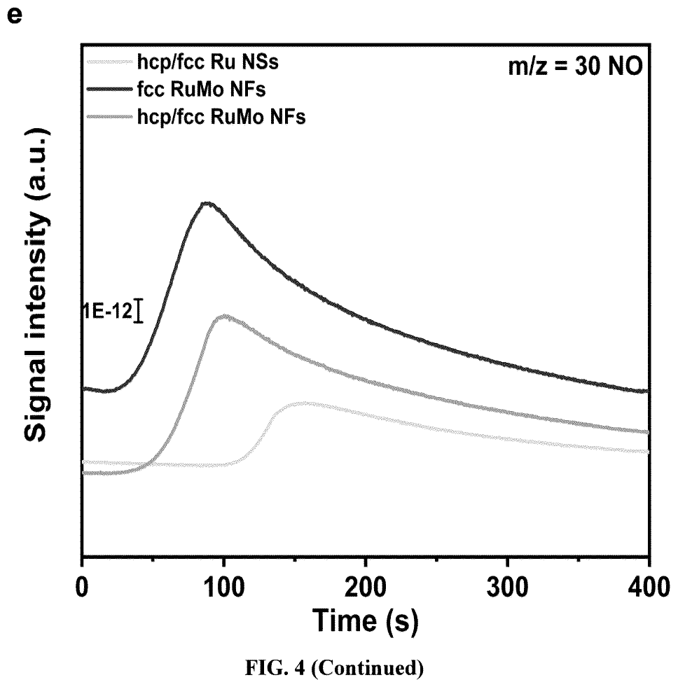

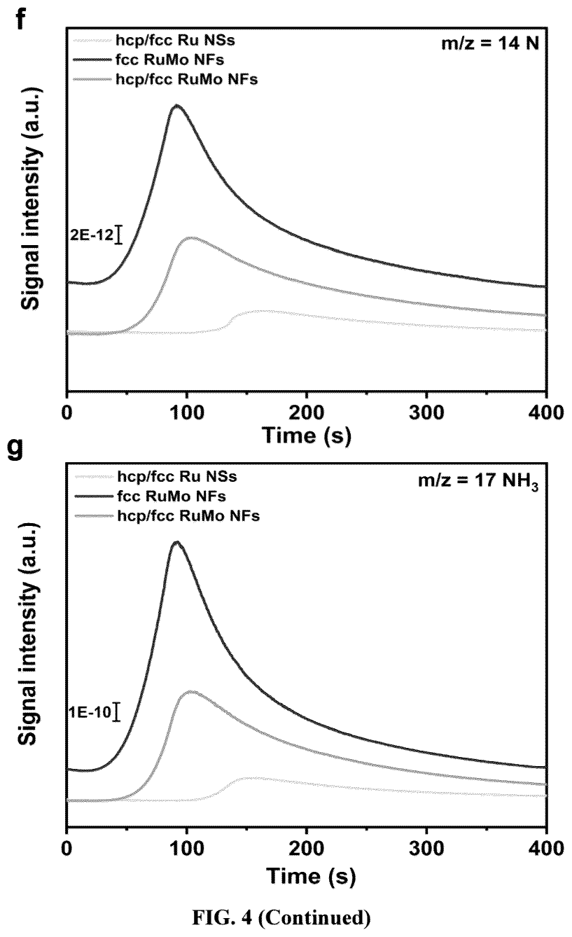

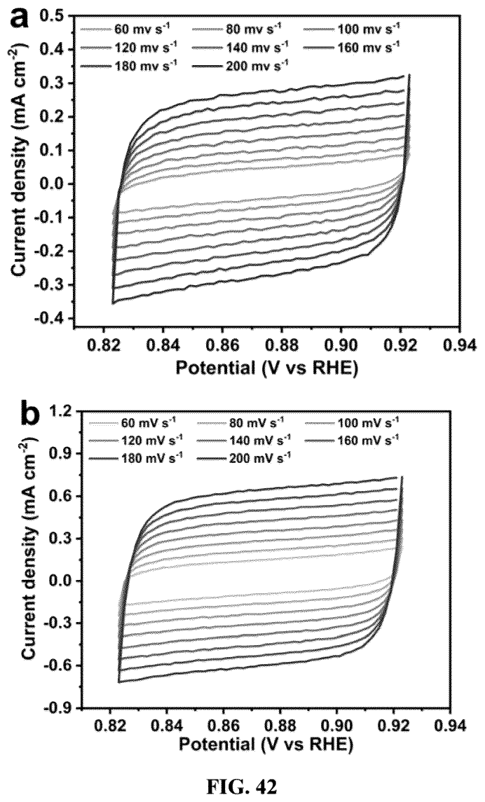

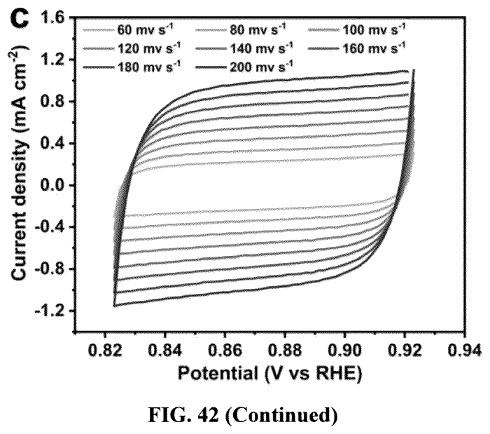

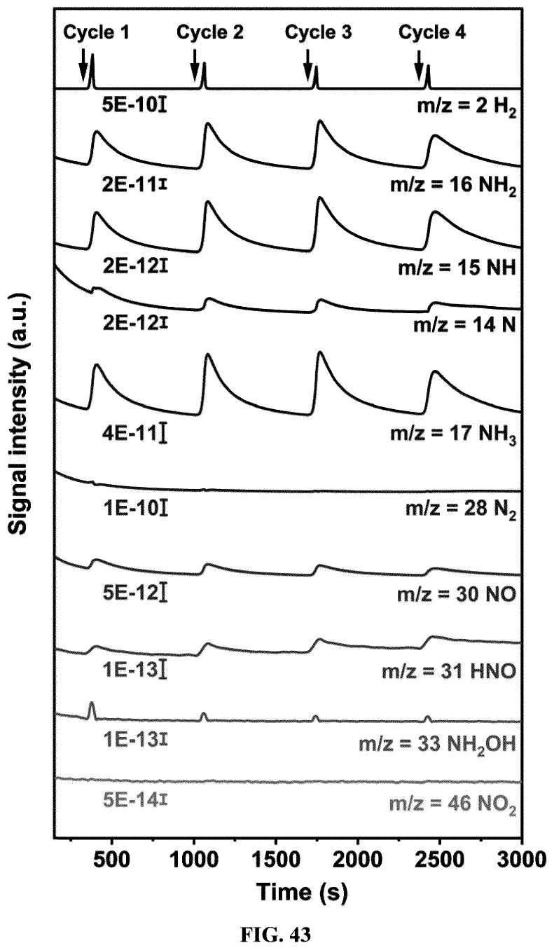

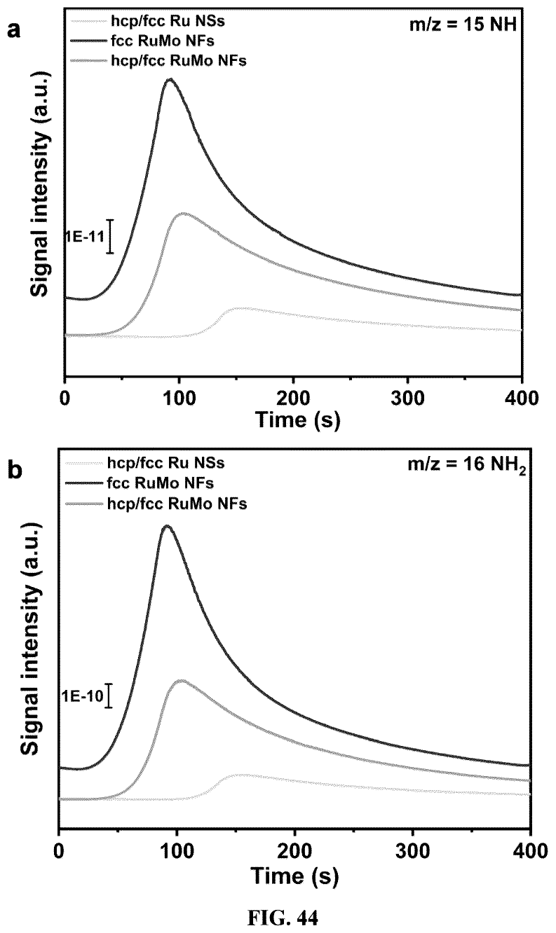

The electrochemically active surface areas (ECSAs) of hcp/fcc Ru NSs, fcc and hcp/fcc RuMo alloy NFs were determined by the electrochemical double-layer capacitance (C_{dl}) method (FIG. 42). Under the same conditions, the C_{dl} of fcc RuMo NFs reached up to 10.87 mF cm⁻², which is 1.5 and 3.3 times those of hcp/fcc RuMo NFs and hcp/fcc Ru NSs (FIG. 4a), suggesting more active sites on the surface of fcc RuMo alloy NFs. In addition, the rapid electron transfer efficiency and fast reaction kinetics of fcc RuMo NFs were identified by their smaller Tafel slope of 203 mV dec⁻¹ than those of hcp/fcc RuMo NFs (242 mV dec⁻¹) and hcp/fcc Ru NSs (338 mV dec⁻¹) (FIG. 4b). To gain a deep understanding of the reaction process, in-situ DEMS was used to detect the possible intermediates and products in the NO₃RR process. During the linear sweep voltammetry (LSV) scans, the mass/charge (m/z) ratios of 2, 14, 15, 16, 17, 28, 30, 31, 33 and 46, which are attributed to H₂, N, NH, NH₂, NH₃, N₂, NO, HNO, NH₂OH and NO₂, respectively, were detected. The stronger peak intensity of H₂ (m/z=2) and weaker peak intensities of NH₃ (m/z=17), NO₂ (m/z=46) and the other nitrogen-contained intermediates were observed for hcp/fcc Ru NSs, indicating their preference for hydrogen evolution during the NO₃RR process (FIG. 43). For unconventional fcc and hcp/fcc RuMo alloy NFs, the much higher peak intensities of NH₃ than H₂ suggests their better catalytic performance toward NH₃ production (FIG. 4c,d). More importantly, it has been reported that there are mainly two reaction pathways for the conversion of NO₃⁻ to NH₃: 1) *NO₃→NO₂→NO→NOH→NH₂OH→NH₂→NH₃; 2) *NO₃→NO₂→NO→N→NH→NH₂→NH₃. For hcp/fcc Ru NSs, hcp/fcc and fcc RuMo alloy NFs, the very weak NH₂OH peaks and much stronger *N peaks reveal that the reaction pathway of NO₃RR on these three samples should follow the latter one, i.e., *NO₃→NO₂→NO→N→NH→NH₂→NH₃. In this reaction pathway, *NO and *N are representative and crucial nitrogen-contained intermediates for the NH₃ production. It was found that fcc RuMo alloy NFs show the peaks attributed to *NO, *N *NH, *NH₂ and NH₃ at much lower potentials than those of hcp/fcc RuMo NFs and hcp/fcc Ru NSs (FIG. 4e-g and FIG. 44), indicating their higher catalytic performance towards nitrate electroreduction to NH₃. These observations are well consistent with the LSV and potential-dependent NH₃ FE results that fcc RuMo NFs can deliver a larger current density at a more positive potential and achieve a higher energy efficiency.

### Theoretical Calculations

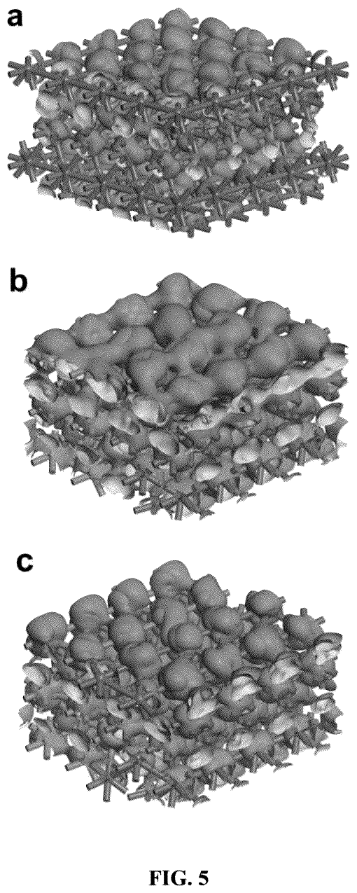

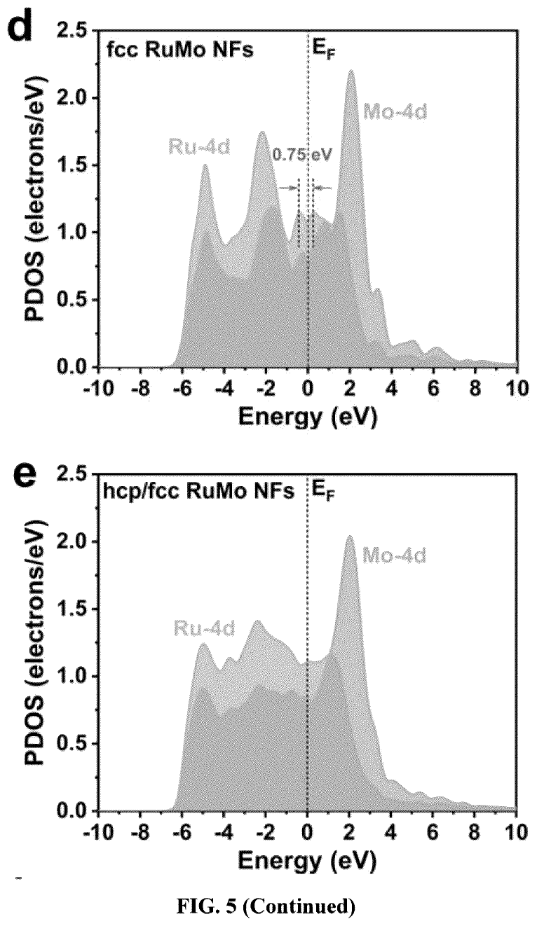

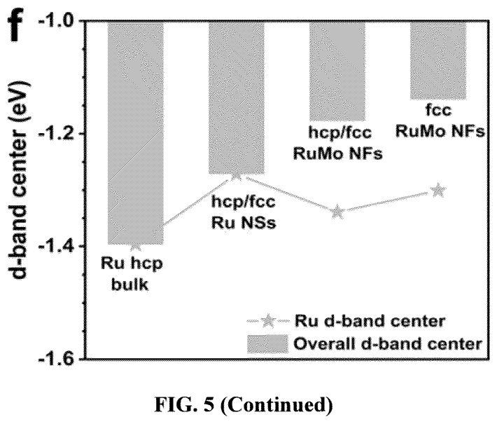

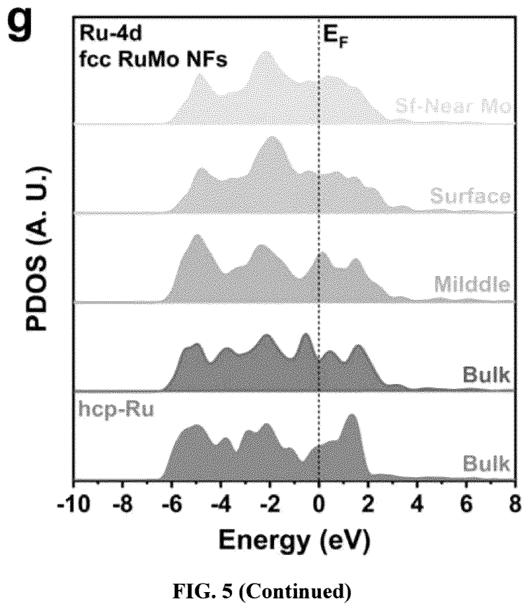

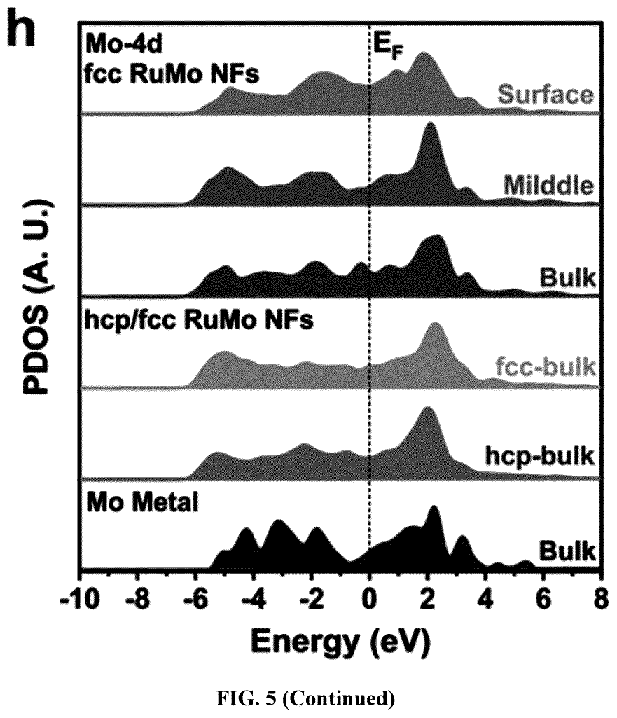

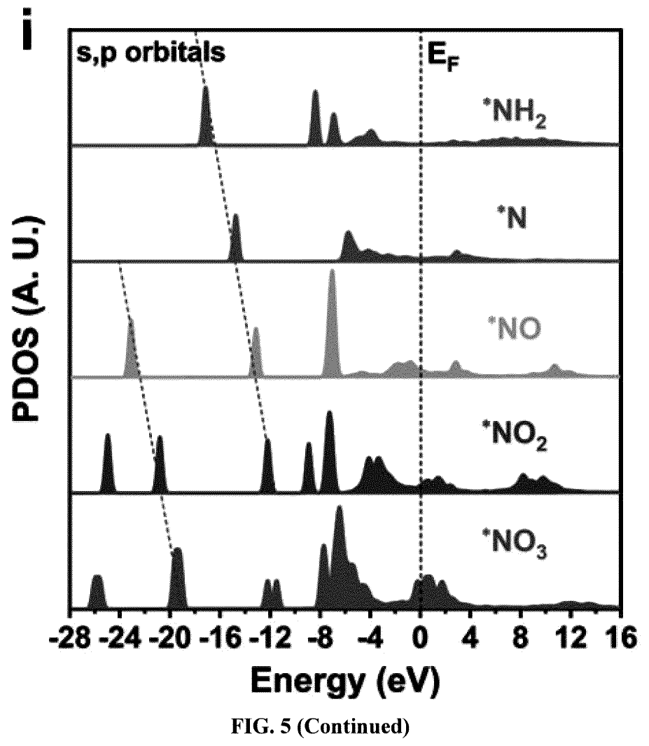

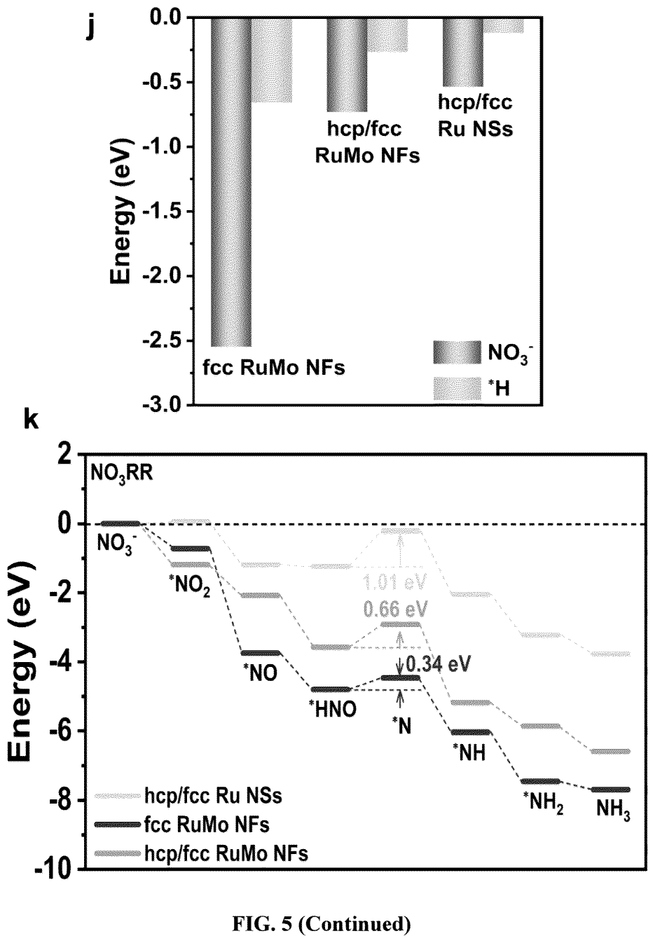

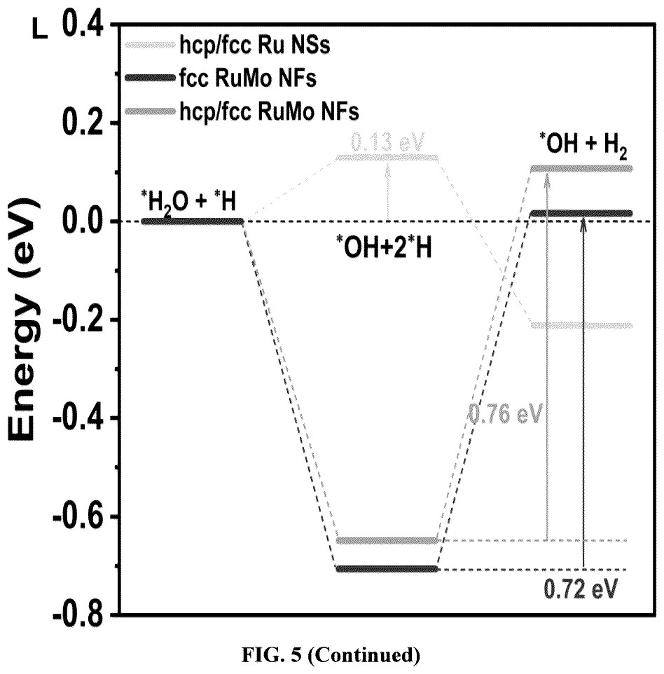

To investigate the origins of superior NO₃RR performance of unconventional fcc phase RuMo alloy NFs, DFT calculations were carried out to demonstrate the intrinsic electroactivity and reaction trends of fcc RuMo NFs and other control samples including hcp/fcc RuMo alloy NFs and hcp/fcc Ru NSs. The influences of crystal phases and compositions have been revealed in the electronic distributions near the Fermi level (E_{F}) in different electrocatalysts (FIG. 5a). For fcc RuMo NFs, the catalyst surface is relatively electron-rich, where the bonding orbitals show more dominant contributions than the anti-bonding orbitals. This facilitates the electron transfer from the electrocatalyst surfaces to improve the NO₃RR performance. In comparison, the hcp/fcc RuMo NF surface becomes less electron-rich with reduced bonding orbital distributions (FIG. 5b). Moreover, it was noticed that bonding orbitals mainly locate near the Mo sites, which are able to improve the electroactivity of surface to improve the adsorption of key intermediates. For hcp/fcc Ru NSs with mixed hcp and fcc phases, it was noted that anti-bonding orbitals become more evident on the surface (FIG. 5c). The electronic distributions indicate that both fcc phase and Mo sites benefit the surface electron transfer. To understand the electronic modulations induced by different phases, the projected partial density of states (PDOSs) are demonstrated (FIG. 5d). For fcc RuMo NFs, it was noticed that Ru-4d orbitals display a minor e_{g}-t_{2g} splitting of 0.75 eV, supporting the superior electron transfer efficiency. The Mo-4d orbitals not only contribute to the electron density near E_{F} but also exhibit good overlapping with Ru-4d orbitals, which uplift the overall d-band center with improved electroactivity and guarantee the efficient site-to-site electron transfer within the electrocatalyst surface. In comparison, the corresponding e_{g}-t_{2g} splitting is enlarged in hcp/fcc RuMo NFs, which increases the energy barrier for electron transfer on the active sites (FIG. 5e). The Mo-4d orbitals still maintain good overlapping with Ru-4d orbitals, which demonstrates that Mo sites are able to preserve the valence states of Ru sites and improve the overall durability of the electrocatalysts. In order to clearly reveal the changes in the overall PDOSs, we have also compared the d-band centers of electrocatalysts and Ru sites, respectively (FIG. 5f). Notably, the overall d-band center shows a gradually upshifting trend from conventional hcp Ru bulk to fcc RuMo NFs, which confirms the highest electroactivity of fcc RuMo NFs with strong adsorption preference to key intermediates during NO₃RR. This also represents an enhanced electroactivity of the unusual fcc phase of Ru than the conventional hcp phase. Compared to hcp/fcc Ru NSs, although the overall d-band centers have been increased in hcp/fcc RuMo NFs and fcc RuMo NFs, the d-band centers of Ru sites are slightly downshifted. This is attributed to the electron transfer from Mo to Ru due to the strong interactions, which are supportive of the XPS results. Then, we demonstrate the site-dependent PDOSs of both Ru and Mo sites in different electrocatalysts (FIG. 5g). For Ru-4d orbitals, the e_{g}-t_{2g} splitting has been significantly reduced from the bulk to the surface, indicating the high electroactivity of the surface. The surface sites have shown a subtle e_{g}-t_{2g} splitting barrier for electron transfer, leading to the fast electron depletion from the catalyst to the intermediates. For hcp/fcc RuMo NFs, the Mo-4d orbitals are slightly upshifted towards E_{F} in the fcc phases than the hcp phases, supporting the higher electroactivity of fcc phase (FIG. 5h). The Mo-4d orbitals display a highly stable electronic structure in fcc RuMo NFs from bulk to the surface, which ensures the efficient and robust adsorption of key intermediates. The surface Mo-4d orbitals have shown increased electron density near E_{F}, which further confirms the high electroactivity of surface sites. In addition, the conversion of intermediates is unraveled through their PDOSs, where each intermediate represents two electron transfers during the NO₃RR (FIG. 5i). For all the key intermediates, a good linear relationship can be observed, which supports a fast conversion process with small energy barriers for remarkable NO₃RR.

The reaction trends were also investigated from the energetic aspects regarding the adsorption of key intermediates (FIG. 5j). Owing to the optimal electronic structure with the highest electroactivity, fcc RuMo alloy NFs display the strongest adsorption strength to both NO₃⁻ and hydrogen, which benefits the consequent reduction and suppresses the competitive hydrogen evolution. In contrast, the adsorption strengths on hcp/fcc Ru NSs become weaker, which results in decreased efficiency of NO₃RR due to the much higher reaction trends for hydrogen evolution. The reaction trends of NO₃RR show that the rate-determining step (RDS) is the conversion from *HNO to *N for all electrocatalysts (FIG. 5k). The fcc RuMo NFs exhibit the smallest RDS barrier of 0.34 eV with the largest reaction energy release (−7.70 eV), which leads to enhanced NO₃RR performance than hcp/fcc RuMo NFs and hcp/fcc Ru NSs. For the reaction trends of hydrogen evolution, the dissociation of water is energetically favored for both fcc RuMo NFs and hcp/fcc RuMo NFs, which supplies abundant active hydrogen atoms for NO₃RR (FIG. 5l). This indicates that the introduction of Mo also facilitates the supply of active hydrogen atoms. In the meantime, the large energy barrier for H₂ formation on fcc RuMo NFs effectively suppresses hydrogen evolution to achieve high selectivity and efficiency of NO₃RR. For hcp/fcc Ru NSs, the hydrogen evolution process meets a small energy barrier of 0.13 eV at the water dissociation, which results in a much higher reaction trend of hydrogen evolution than both fcc RuMo NFs and hcp/fcc RuMo NFs due to the reduced barriers of RDS.

Demonstration of Zn—NO₃⁻ Batteries

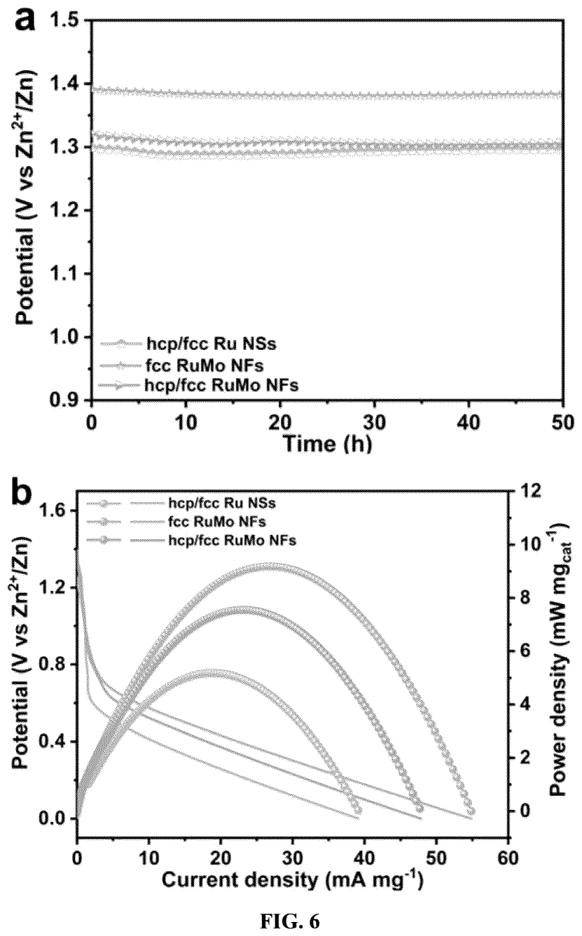

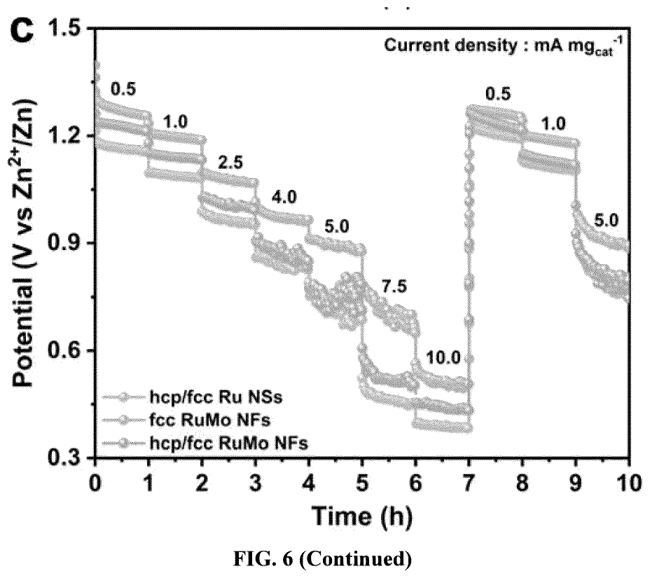

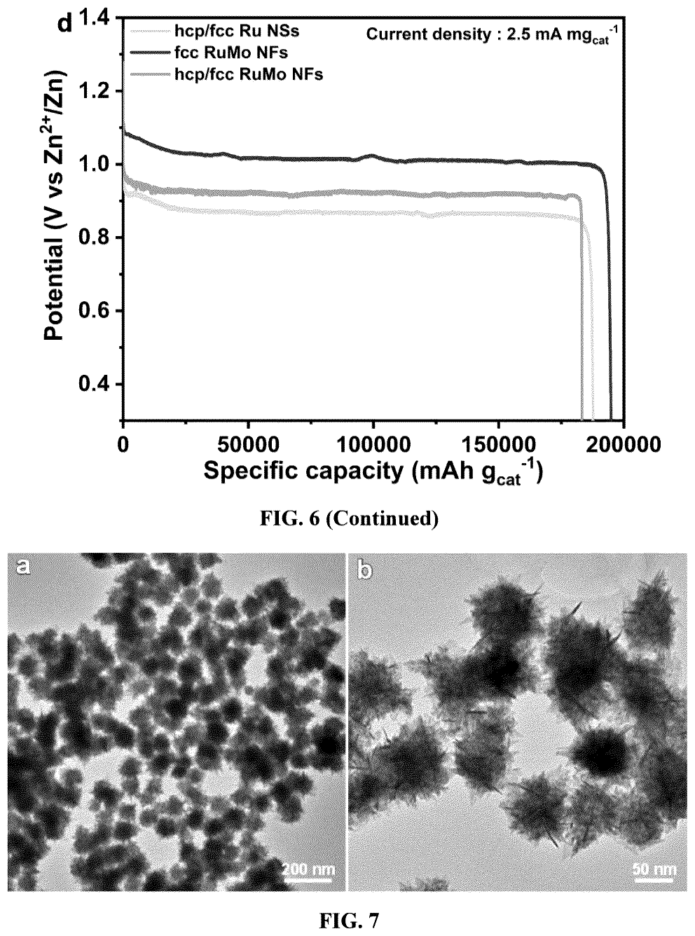

Ammonia has been regarded as a kind of potential energy carrier due to its high energy density (4.32 kW h L⁻¹). Given the excellent catalytic activity of unconventional fcc phase RuMo alloy NFs in NO₃RR for NH₃ production, Zn—NO₃⁻ electrochemical batteries were assembled in which both the electricity generation and NH₃ production can be simultaneously realized. Typically, during the discharge process, the NO₃RR proceeds at the cathode, while the dissociation of Zn occurs at the anode (4Zn+8OH⁻→4ZnO+4H₂O+8e⁻). FIG. 6a shows the open circuit voltage (OCV) profiles of Zn—NO₃⁻ batteries with hcp/fcc Ru NSs, fcc and hcp/fcc RuMo alloy NFs as the cathode catalysts. It was observed that fcc RuMo NFs demonstrate a much higher OCV of 1.362 V (vs Zn²⁺/Zn) than hcp/fcc RuMo NFs and hcp/fcc Ru NSs, which keeps stable in the following 50 h test period. During the discharge process, the output current density gradually increases with a negatively proceeding voltage (FIG. 6b). Compared to hcp/fcc Ru NSs and hcp/fcc RuMo NFs, fcc RuMo NFs can deliver a much larger current density during the discharge process, and achieve the maximum power density of 9.19 mW mg_{cat}⁻¹ at 0.342 V (vs Zn²⁺/Zn), which is 1.8 and 1.2 times those of hcp/fcc Ru NSs (5.18 mW mg_{cat}⁻¹ at 0.273 V (vs Zn²⁺/Zn)) and hcp/fcc RuMo NFs (7.55 mW mg_{cat}⁻¹ at 0.336 V (vs Zn²⁺/Zn)), respectively. Moreover, the Zn—NO₃⁻ battery with fcc RuMo NFs displays an excellent rate performance (FIG. 6c). Although polarization is observed with increasing the current density from 0.5 to 10 mA mg_{cat}⁻¹, the Zn—NO₃⁻ battery with fcc RuMo NFs can still output a higher potential than hcp/fcc Ru NSs and hcp/fcc RuMo NFs, and the voltage could recover when the current density goes back to 0.5, 1.0, and 5 mA mg_{cat}⁻¹. In addition, Zn—NO₃⁻ batteries with fcc RuMo NFs deliver an outstanding specific capacity of 195,042 mAh g_{cat}⁻¹ under the discharge current density of 2.5 mA mg_{cat}⁻¹ (FIG. 6d). These results indicate the promising application potential of the unconventional fcc phase RuMo alloy NFs in Zn—NO₃⁻ batteries toward sustainable energy supply systems.

In summary, unconventional fcc phase RuMo alloy NFs and heterophase hcp/fcc RuMo alloy NFs were successfully synthesized via a facile one-pot solvothermal method. It was observed that fcc RuMo NFs demonstrate superior NO₃RR performance over both hcp/fcc Ru NSs and hcp/fcc RuMo NFs. Remarkably, fcc RuMo NFs deliver an excellent NH₃ FE of 95.2% and high half-cell EE of 41.9% at 0 V (vs RHE), as well as a maximum NH₃ yield rate of 32.7 mg h⁻¹ mg_{cat}⁻¹ at −0.1 V (vs RHE). Moreover, fcc RuMo NFs also show outstanding catalytic durability during the 20 consecutive electrolysis cycles and the long-term chronoamperometry test. In addition, when the nitrate concentration is as low as 10 mM, the NH₃ FE of 69.7% can still be achieved with fcc RuMo NFs at 0 V (vs RHE). In-situ DEMS results uncovered that fcc RuMo NFs exhibit much lower overpotential for NH₃ electrosynthesis than those of hcp/fcc RuMo NFs and hcp/fcc Ru NSs in NO₃RR. DFT calculations have indicated the optimizations of electronic structure induced by both the fcc phase and the introduction of Mo sites, which improve the surface electroactivity to enhance adsorptions of key intermediates and accelerate electron transfer for efficient reduction processes. Owing to the electronic modulations, fcc RuMo NFs display the strongest adsorption preferences of key intermediates due to the highest d-band center, which not only reduces the RDS barrier but also largely suppresses the competitive hydrogen evolution process. Besides, the successful demonstration of high-performance Zn—NO₃⁻ batteries with fcc RuMo alloy NFs as the cathode catalyst suggest their great application potential in the energy supply systems. This work not only provides a feasible method to synthesize unconventional phase metal/alloy nanomaterials, but also offers an effective strategy in promoting the NO₃RR performance towards a sustainable nitrogen cycle.

### Experimental Section

### Chemicals and Reagents

Triruthenium dodecacarbonyl (Ru₃(CO)₁₂, 98%) was bought from Energy Chemical. Sodium nitroprusside and molybdenum hexacarbonyl (Mo(CO)₆, 98%) were purchased from Alfa Aesar. Oleylamine (OAm, 80%-90%), glucose (99%), n-heptanol (99%), salicylic acid (AR, 99.5%), p-aminobenzenesulfonamide (ACS, 99%), sodium hydroxide (NaOH, AR, 96%), potassium hydroxide (KOH, AR, 99%), trisodium citrate dihydrate (98%), potassium nitrate (KNO₃, 99%), potassium nitrite (KNO₂, 99.99% metals basis), ammonium chloride (ACS, 99.5%), zinc acetate (Zn(Ac)₂, AR, 99.0%), N-(1-naphthyl)ethylenediamine dihydrochloride (AR, 98%), 4-(dimethylamino)benzaldehyde (ACS, 99%), phosphoric acid (H₃PO₄, ACS, ≥85 wt. % in H₂O, p=1.70 g/mL), potassium nitrate-¹⁵N (99 atom %, ≥98.5%), ammonium chloride-¹⁵N (98 atom %, ≥98%) and maleic acid (AR, ≥99.0% (HPLC)) were supplied by Shanghai Aladdin Biochemical Technology Co., Ltd. Citric acid (AR, >99%), and solution of sodium hypochlorite (NaClO, 0.1 M) were bought from Macklin. Ethanol (Absolute, ≥99.9%), sulfuric acid (ACS, 98%), hydrochloric acid (ACS, wt. 37%) and hexane (Absolute, ≥99%) were purchased from Anaqua Global International Inc. Limited. All the chemicals and reagents were used as received without further purification. Deionized (DI) water used in the experiments was obtained from the Milli-Q Plus System with a resistance of 18.2 MΩ·cm.

### Synthesis of Face-Centered Cubic (Fcc) RuMo Alloy Nanoflowers (NFs)

In a typical synthesis, 4 mg of Ru₃(CO)₁₂, 5 mg of Mo(CO)₆ and 5 mg of glucose were added into 2 mL of OAm. Then 1 mL of salicylic acid solution (10 mg/mL in n-heptanol) was added into the above solution. Subsequently, the growth solution was transferred to a Teflon-lined autoclave, and heated from room temperature to 200° C. and maintained at this temperature for 48 h. After cooling the reactor to room temperature naturally, the final products were collected by centrifugation and washed with 3 mL of the mixture of ethanol and hexane (v/v=1/2) three times. The obtained fcc RuMo alloy NFs were re-dispersed into hexane for further use.

### Synthesis of Heterophase Hexagonal Close-Packed (Hcp)/Fcc RuMo Alloy NFs

In a typical synthesis, 4 mg of Ru₃(CO)₁₂, 5 mg of Mo(CO)₆ and 5 mg of glucose were added into 2 mL of OAm. Then 1 mL of citric acid solution (50 mg/mL in n-heptanol) was added into the above solution. After that, the growth solution was transferred to a Teflon-lined autoclave, and heated from room temperature to 200° C. and maintained at this temperature for 48 h. After cooling the reactor to room temperature naturally, the final products were acquired by centrifugation and washed with 3 mL of the mixture of ethanol and hexane (v/v=1/2) for three times. The as-synthesized hcp/fcc RuMo alloy NFs were re-dispersed into hexane for further use.

### Synthesis of Heterophase Hcp/Fcc Ru Nanosheets (NSs)

In a typical synthesis, 4 mg of Ru₃(CO)₁₂ and 5 mg of glucose were added into 2 mL of OAm. Then 1 mL of salicylic acid solution (10 mg/mL in n-heptanol) was added into the above solution. After that, the growth solution was transferred to a Teflon-lined autoclave, and heated from room temperature to 200° C. and maintained at this temperature for 12 h. After the reaction, the final products were collected by centrifugation and washed with 3 mL of the mixture of ethanol and hexane (v/v=1/1) three times. The obtained hcp/fcc Ru NSs were re-dispersed into hexane for further use.

### Characterization

Powder X-ray diffraction (XRD) patterns were recorded on a Rigaku SmartLab X-ray diffractometer with Cu Kα X-ray source (λ=1.5406 Å). The transmission electron microscopy (TEM) and high-resolution TEM (HRTEM) images were taken on a JEOL-2100F transmission electron microscope operated at 200 kV. The spherical aberration-corrected high-angle annular dark-field scanning TEM (HAADF-STEM) images were obtained on a high-resolution aberration-corrected TEM (JEOL JEM-ARM200F). Scanning transmission microscopy (SEM) measurements were conducted on QUANTA 250. X-ray photoelectron spectroscopy (XPS) tests were performed on Thermo Scientific Nexsa spectrophotometer with Al-Kα radiation system. The calibration of XPS spectra was performed by using the C Is peak at 284.8 eV. X-ray absorption measurements, including XANES and EXAFS were obtained in ambient condition at TLS 01C (National Synchrotron Radiation Research Center, Taiwan). XAS data normalization and background subtraction were performed using Demeter 0.9.25 software package. The edge energy of X-ray absorption near edge structure (XANES) spectra was determined from the inflection point in the leading edge, i.e., the maximum in the first derivative of the leading edge of XANES spectra. The coordination parameters were obtained by a least square fit in the R-space Fourier transformed data using Artemis. The amplitude reduction factor (S₀²) was determined as 0.7 for Ru K-edge by fitting a reference spectrum of Ru foil, and then it was used for fitting all the other Ru K-edge EXAFS spectra. In-situ differential electrochemical mass spectrometry (DEMS) studies were performed on a Linglu DEMS analysis system from Shanghai Linglu Instrument Co., Ltd.

### Electrochemical NO₃RR Measurement

Preparation of the working electrode. The as-prepared catalysts were further centrifuged and washed by the mixture of ethanol and hexane (v/v=1/1) for two times to remove the surfactants on the catalyst surface. Typically, to prepare the working electrode, 1.6 mg of the catalyst were added into the mixture of 368 μL of isopropanol and 32 μL of Nafion solution. Subsequently, it was ultrasonicated in an ice-water bath for about 0.5 h to enable the well dispersion of the catalyst ink. After that, 50 μL of the catalyst ink were dropped onto the carbon paper (1 cm×1 cm). Finally, the working electrodes were dried in vacuum oven at room temperature for around 2 h.

NO₃RR performance test. The electrochemical NO₃RR performance test was conducted on an Ivium-n-Stat electrochemical workstation using a standard H-type cell separated by Nafion 117 membrane. In the typical three-electrode system, Pt plate, Ag/AgCl (filled with saturated KCl solution) and catalyst supported on carbon paper were used as the counter, reference and working electrodes, respectively. All the potentials were converted to the reversible hydrogen electrode (RHE) scale by the equation: E (vs RHE)=E (vs Ag/AgCl)+0.197 V+0.059×pH. All the measured potentials were manually 85% compensated. The solution containing 0.1 M KOH and 100 mM KNO₃ was used as the electrolyte, which was purged with high purity argon (Ar) for at least 30 mins before the test. Then, 30 mL of electrolyte were added into both the anode and cathode compartments of the H-type cell. The linear sweep voltammetry (LSV) curve was acquired at a scan rate of 5 mV s⁻¹ with the potential range from 0.3 to-0.4 V (vs RHE). The chronoamperometry test was conducted for 1 h at each potential under a stirring rate of 600 rpm. The consecutive recycling stability test was performed at 0 V (vs RHE) with the stirring rate of 600 rpm for 1 h of each cycle. After finishing the electrolysis of each cycle, the electrolyte was taken out for UV-vis analysis and new electrolyte was immediately added into the cell. The next cycle electrolysis was performed under the same conditions. For the long-term chronoamperometry test, the electrochemical measurement was conducted at 0 V (vs RHE). Typically, 200 μL of electrolyte were taken out for UV-vis analysis at each time. Cyclic voltammetry (CV) curves were collected at the non-Faradaic region with different scan rates of 60, 80, 100, 120, 140, 160, 180 and 200 mV s⁻¹ to determine the electrochemical double-layer capacitance (C_{dl}). The electrochemical active surface area (ECSA) can be calculated according to the following equation: ECSA=C_{dl}/Cₛ, where Cₛ is the specific capacitance (40 μF cm⁻²).

### Electrochemical In-Situ DEMS Test

The in-situ DEMS test was performed with a homemade electrochemical cell. Pt wire, Ag/AgCl and catalyst supported on carbon paper were used as the counter, reference and working electrodes, respectively. The electrolyte composed of 0.1 M KOH and 100 mM KNO₃ was purged with high purity Ar for at least 30 mins before the measurement. The LSV curves were acquired from 0.2 to-0.2 V (vs RHE) after the baseline of mass signals became smooth and steady. Meanwhile, the mass signals were recorded during the LSV scanning. After the LSV test was finished, the next cycle of LSV test and mass signal collection started again when the mass signal intensity returned to the baseline.

### Isotope Labeling Experiments

The isotope labeling experiments were performed by using K¹⁵NO₃ as the feeding nitrogen source instead of K¹⁴NO₃. According to the aforementioned electrocatalytic method, 30 mL of electrolyte containing 0.1 M KOH and 0.1 M K¹⁵NO₃ were added into the cathode compartment of the H-type cell. After electrolysis for 1 h, the electrolyte was collected and a certain amount of maleic acid was added into it, resulting in the concentration of 0.4 mg mL⁻¹ for maleic acid. After that, 0.45 mL of the above solution was mixed with 50 μL of deuterium oxide (D₂O) for the ¹H-NMR (300 MHz) test. A series of ¹⁵N-¹⁵NH₄⁺ (or ¹⁴N-¹⁴NH₄⁺) solutions with different ¹⁵NH₄⁺ (or ¹⁴NH₄⁺) concentrations were prepared using ¹⁵NH₄Cl (or ¹⁴NH₄Cl) (98 atom %, ≥98%). The calibration curves were obtained by correlating the relationship between ¹⁵NH₄⁺ (or ¹⁴NH₄⁺) concentration and the peak area ratio of H-¹⁵NH₄⁺ (or H-¹⁴NH₄⁺) and H-maleic acid.

### Product Detection of NO₃RR

Determination of ammonia. The concentration of NH₃ was spectrophotometrically determined by using the indophenol blue method. Typically, 2 mL of pre-diluted electrolyte were taken out and mixed with 2 mL of 1 M NaOH solution containing 5 wt. % salicylic acid and 5 wt. % trisodium citrate dihydrate. Then, the above solution was mixed with 1 mL of 0.05 M NaClO solution and 0.2 mL of an aqueous solution of 1 wt. % sodium nitroprusside. After the above mixture was kept in the dark for 2 h, the absorption spectrum was acquired using an UV-vis spectrophotometer (Shimadzu-UV1700) at the wavelength of 654 nm. The calibration curve of ammonia concentration and absorbance was prepared by using a series of standard NH₄Cl solutions.

Determination of nitrite. Firstly, 4 g of p-aminobenzenesulfonamide, 0.2 g of N-(1-Naphthyl)ethylenediamine dihydrochloride, and 10 mL of phosphoric acid (ρ=1.70 g/mL) were added into 50 mL of ultrapure water. After ultrasonication for about 2 mins, the obtained transparent solution was used as the color reagent. Then, 5 mL of dilution electrolyte were mixed with 0.1 mL of color regent. After 20 mins, the absorption spectrum was taken by using an UV-vis spectrophotometer (Shimadzu-UV1700) at the wavelength of 540 nm. A series of standard potassium nitrite solutions were prepared to obtain the calibration curve.

Determination of hydrazine. Hydrazine (N₂H₄) in the electrolyte was determined by the Watt and Chrisp method. Typically, 5.99 g of 4-(dimethylamino)benzaldehyde, 30 mL of hydrochloric acid and 300 mL of ethanol were thoroughly mixed and used as a color reagent. Then, 2.5 mL of electrolyte were collected from the cathode compartment and mixed with 2.5 mL of the above color reagent. After standing in the dark for about 20 mins at room temperature, the absorbance of the obtained solution was measured at a wavelength of 457 nm by using the UV-vis spectrophotometer (Shimadzu-UV1700). The concentration-absorbance curve was made by standard hydrazine monohydrate solutions with a series of known concentrations.

### Calculation of the Faradaic Efficiency (FE) and Yield Rate (R)

In this work, the FE of NH₃, NO₂⁻ or N₂H₄ was calculated as follows:

$$\begin{matrix}{FE}_{{NH}_{3}} = ( 8 \times F \times {C}_{{NH}_{3}} \times V ) / ( {M}_{{NH}_{3}} \times Q ) \times 100 \% \\ {FE}_{{NO}_{2}^{-}} = ( 2 \times F \times {C}_{{NO}_{2}^{-}} \times V ) / ( {M}_{{NO}_{2}^{-}} \times Q ) \times 100 \% \\ {FE}_{{N}_{2} {H}_{4}} = ( 7 \times F \times {C}_{{H}_{2} {H}_{4}} \times V ) / ( {M}_{{N}_{4} {H}_{4}} \times Q ) \times 100 \%\end{matrix}$$

The yield rate of NH₃ was calculated according to the following equation:

$${R}_{{NH}_{3}} = ( {C}_{{NH}_{3}} \times V ) / ( {m}_{cat} \times t )$$

where F is the Faraday constant (96485 C mol⁻¹), C_{NO2-}, C_{NH3} and C_{N2H4} represent the concentration of NO₂⁻, NH₃ and N₂H₄ (mg/L), V is the volume of the electrolyte (L), M_{NO2-}, M_{NH3} and M_{N2H4} denote the molar mass of NO₂⁻, NH₃ and N₂H₄ (mg/mol), Q is the total amount of charge (C), m_{cat} is the total amount of catalyst (mg), and t is the potentiostatic test time (h).

### Calculation of the Half-Cell Energy Efficiency for NH₃ Synthesis

The energy efficiency is defined as the ratio of chemical energy to applied electrical power, which was calculated by the following equation:

$${EE}_{NH 3} = \frac{( {E}_{OER}^{0} - {E}_{NH 3}^{0} ) \times {FE}_{NH 3}}{{E}_{OER} - {E}_{NH 3}}$$

where E_{OER}⁰ represents the equilibrium potential of water oxidation (1.23 V vs RHE); E_{NH3}⁰ (0.69 V vs RHE under alkaline condition) is the equilibrium potential of nitrate electroreduction to NH₃; FE_{NH3} is the Faradaic efficiency of NH₃; E_{OER} is the applied potential for oxygen evolution reaction (here assuming the overpotential for water oxidation is zero, i.e., E_{OER} is 1.23 V vs RHE); E_{NH3} is the applied potential for NH₃ production.
   Assembly of Zinc-Nitrate (Zn—NO₃⁻) Battery

A typical H-type cell separated by a bipolar membrane was used to assemble the Zn—NO₃⁻ battery. The catalyst supported on carbon paper and a polished Zn foil were applied as the working and counter electrodes, respectively. 25 mL of electrolyte containing 1 M KOH and 0.02 M Zn(Ac)₂ were added into the anode compartment, while 25 mL of electrolyte composed of 0.1 M KOH and 100 mM KNO₃ were added into the cathode compartment. The discharging curves were acquired by an Ivium-n-Stat electrochemical workstation with the sweep rate of 5 mV s⁻¹. The galvanostatic discharge measurements of the assembled batteries were carried out using LAND battery test systems (CT2001A, Wuhan LAND Electronic Co. Ltd).

### Theoretical Calculations Setup

In this work, density functional theory (DFT) calculations embedded in CASTEP packages have been applied to investigate both electronic structures and reaction trends of unconventional fcc and hcp/fcc RuMo alloy NFs. To accurately describe the exchange-correlation interactions in the materials, we have selected the generalized gradient approximation (GGA) and Perdew-Burke-Ernzerhof (PBE) functionals. By choosing the ultrafine quality with the ultrasoft pseudopotentials, the plane-wave cutoff energy has been set to 380 eV by default. The Broyden-Fletcher-Goldfarb-Shannon (BFGS) algorithm has been introduced for all the energy minimizations and the k-point has been set to coarse quality based on the balance between calculation efficiency and accuracy. We have considered three different electrocatalysts in this work. The fcc RuMo NFs have been constructed by cleaving the (111) surfaces of fcc Ru with 5-layer thickness in a 4×4×1 supercell. The hcp/fcc RuMo NFs and hcp/fcc Ru NSs are built by a combination of the hep and fcc phases of Ru, which include 84 atoms with 5-layer thickness. Based on the experimental characterizations, fcc RuMo NFs and hcp/fcc RuMo NFs have a close composition of Ru₇₂Mo₈ and Ru₇₆Mo₈, respectively. To guarantee sufficient geometry optimizations, 20 Å vacuum space has been introduced in the c-axis for all the electrocatalyst surfaces. To achieve sufficient geometry optimizations, we have applied stringent convergence criteria including the Hellmann-Feynman forces and the total energy difference should not exceed 0.001 eV/Å and 5×10⁻⁵ eV/atom, respectively.

What is claimed is:

1. A ruthenium-molybdenum (RuMo) alloy nanoflower particle comprising: a plurality of RuMo nanosheets, wherein the plurality of RuMo nanosheets are in a form of a nanoflower.

2. The RuMo alloy nanoflower particle of claim 1, wherein the plurality of RuMo nanosheets comprise RuMo in a face-centered cubic (fcc) phase or a heterophase comprising a hexagonal close-packed (hcp) phase and a face-centered cubic (fcc) phase.

3. The RuMo alloy nanoflower particle of claim 1, wherein the RuMo alloy nanoflower particle has a diameter of 20-100 nm.

4. The RuMo alloy nanoflower particle of claim 1, wherein the plurality of RuMo nanosheets have an average thickness of 2.3-3.3 nm or 2.6-3.6 nm.

5. The RuMo alloy nanoflower particle of claim 1, wherein the plurality of RuMo nanosheets have an average thickness of 2.6-3.0 nm or 2.9-3.3 nm.

6. The RuMo alloy nanoflower particle of claim 1, wherein the RuMo alloy nanoflower particle comprises Ru and Mo in an atomic ratio of 85:15 to 95:5, respectively.

7. The RuMo alloy nanoflower particle of claim 1, wherein the RuMo alloy nanoflower particle comprises Ru and Mo in an atomic ratio of 89.9:10.1 to 91.4:9.6, respectively.

8. The RuMo alloy nanoflower particle of claim 1, wherein the plurality of RuMo nanosheets comprise RuMo in a face-centered cubic (fcc) phase; the plurality of RuMo nanosheets have an average thickness of 2.6-3.0 nm; and the RuMo alloy nanoflower particle comprises Ru and Mo in an atomic ratio of 89.9:10.1 to 91.4:9, respectively; or the plurality of RuMo nanosheets comprise RuMo in a heterophase comprising a hexagonal close-packed (hcp) phase and a face-centered cubic (fcc) phase; the plurality of RuMo nanosheets have an average thickness of 2.9-3.3 nm; and the RuMo alloy nanoflower particle comprises Ru and Mo in an atomic ratio of 89.9:10.1 to 91.4:9, respectively.

9. The RuMo alloy nanoflower particle of claim 1, wherein the plurality of RuMo nanosheets comprise RuMo in a face-centered cubic (fcc) phase; the plurality of RuMo nanosheets have an average thickness of 2.6-3.0 nm; and the RuMo alloy nanoflower particle comprises Ru and Mo in an atomic ratio of 89.9:10.1 to 91.4:9, respectively.

10. The RuMo alloy nanoflower particle of claim 1, wherein the RuMo alloy nanoflower particle is prepared by a method comprising: combining Ru₃(CO)₁₂, Mo(CO)₆, glucose, and citric acid or salicylic acid in a solvent comprising oleylamine thereby forming a reaction solution and heating the reaction solution thereby forming the RuMo alloy nanoflower particle.

11. An electrode comprising the RuMo alloy nanoflower particle of claim 1 and a base electrode.

12. An electrochemical cell comprising:
the electrode of claim 11;
a counter electrode;
optionally a reference electrode; and
an electrolyte solution between and in contact with the electrode, the counter electrode, and optionally the reference electrode.

13. A method of producing ammonia, the method comprising: providing the electrochemical cell of claim 12, wherein the electrolyte solution comprises a substrate selected from the group consisting of a nitrate salt, a nitrite salt, nitric oxide, nitrogen (N₂), and a mixture thereof; and applying a potential between the electrode and the counter electrode resulting in the electrolytic reduction of the substrate thereby forming ammonia.

14. The method of claim 13, wherein the potential is-0.1 to 0.05 volts vs reversible hydrogen electrode.

15. The method of claim 13, wherein the nitrate salt is present in the electrolyte solution at a concentration of 0.01 to 0.1 M.

16. The method of claim 13, wherein the method has a NH₃ Faradaic efficiency (FE) of 91.7%-95.2% at −0.1 to 0 V vs reversible hydrogen evolution.

17. A method of preparing the RuMo alloy nanoflower particle of claim 1, the method comprising: combining Ru₃(CO)₁₂, Mo(CO)₆, glucose, and citric acid or salicylic acid in a solvent comprising oleylamine thereby forming a reaction solution and heating the reaction solution thereby forming the RuMo alloy nanoflower particle.

18. The RuMo alloy nanoflower particle of claim 16, wherein the reaction solution is heated at a temperature of 150-250° C.
